(19) United States
(12) Patent Application Publication
(10) Pub. No.: US 2025/0044026 A1
(43) Pub. Date: Feb. 6, 2025

(54) TOWEL RACK

(71) Applicant: Vistarock Holdings LLC, Keller, TX (US)

(72) Inventors: James Wallander, Keller, TX (US); William Wallander, Dallas, TX (US); Paul Dowd, Bronxville, NY (US); Norman Barrigas, Bronxville, NY (US); David Block, Brooklyn, NY (US)

(73) Assignee: Vistarock Holdings LLC, Keller, TX (US)

(21) Appl. No.: 18/717,593

(22) PCT Filed: Dec. 8, 2022
(86) PCT No.: PCT/US2022/052226

§ 371 Date: Jun. 7, 2024

Related U.S. Application Data
(60) Provisional application No. 63/288,173, filed on Dec. 10, 2021.
(60) Provisional application No. 63/344,449, filed on May 20, 2022.
(60) Provisional application No. 63/347,642, filed on Jun. 1, 2022.

(51) Int. Cl. F26B 21/06; A47K 10/06; F26B 3/04

(52) U.S. Cl. CPC F26B 21/06; A47K 10/06; F26B 3/04

(57) ABSTRACT

A towel rack includes a laterally extending cross structure and a fluid flow path traversing the laterally extending cross structure. A forced air unit is positioned in the laterally extending cross structure. A heating element heats air which is moved via the forced air unit through the fluid flow path. A vent is in fluid communication with the fluid flow path.

### CROSS-REFERENCE TO RELATED APPLICATIONS

This application claims priority under 35 U.S.C. § 119 (e) to U.S. Provisional Application No. 63/288,173, filed Dec. 10, 2021, U.S. Provisional Application No. 63/344,449, filed May 20, 2022, and U.S. Provisional Application No. 63/347,642, filed Jun. 1, 2022, each of which is expressly incorporated by reference herein.

### BACKGROUND

The present disclosure relates to a towel rack and, more particularly, to a towel rack for warming and drying a towel.

Using a warm and dry towel to dry oneself off is a comforting feeling and preferable alternative to a damp cold towel. In order to have readily available warm dry towels, some users utilize towel warmers. While these towel warmers provide some warmth, they do not evenly warm/dry towels and mostly heat the towel at the point of contact. Therefore, a need exists for an apparatus to evenly warm and dry a towel.

### SUMMARY

The present disclosure includes one or more of the features recited in the appended claims and/or the following features which, alone or in any combination, may comprise patentable subject matter.

According to a first aspect of the disclosed embodiments, a towel rack includes a laterally extending cross structure. A fluid flow path traverses the laterally extending cross structure. A forced air unit is positioned in the laterally extending cross structure. A heating element heats air which is moved via the forced air unit through the fluid flow path. A vent is in fluid communication with the fluid flow path. The laterally extending cross structure is configured to support a towel and cause the towel to receive air which emitted from the vent.

In some embodiments of the first aspect, the laterally extending cross structure can include a plurality of cross bars forming a cross bar conduit. The plurality of cross bars can extend between a first lateral support and a second lateral support. The plurality of cross bars can include a first plurality of cross bars forming a first cross bar conduit. A second plurality of cross bars can form a second cross bar conduit. The vent can include a first vent traversing the first cross bar conduit. A second vent can traverse the second cross bar conduit. The second cross bar conduit can be larger than the first cross bar conduit.

Optionally, in the first aspect, the laterally extending cross structure can include a first lateral sidewall extending from a base. A second lateral sidewall can extend from the base. Ends of the first lateral sidewall and ends of the second lateral sidewall can be configured to form a space between the first lateral sidewall and the second lateral sidewall. The vent can be configured to emit the air into the space.

It may be desired, in the first aspect, that a first lateral support and a second lateral support are provided. The laterally extending cross structure can extend between the first lateral support and the second lateral support. The fluid flow path can traverse the laterally extending cross structure and at least one of the first lateral support and the second lateral support. The vent can be located in at least one of the laterally extending cross structure, the first lateral support, and the second lateral support and can be in fluid communication with the fluid flow path. The laterally extending cross structure, the first lateral support, and the second lateral support can be configured to cause the towel to form a space which receives the air which emitted from the vent. The laterally extending cross structure can be formed integrally with the first lateral support and the second lateral support as a panel and the cross structure can extend from a base.

It can be contemplated, in the first aspect, that the cross structure is formed in a lattice configuration. An aromatherapy cartridge can be in fluid communication with the fluid flow path so that the air emitted from the vent is mixed with aromatherapy particles from the aromatherapy cartridge. The towel rack can be configured to kill at least one of a pathogen, germ, bacterium, a virus, or combinations thereof. A horizontally moveable slat can slide along the laterally extending cross structure to facilitate increasing heat capture. The towel rack can be configured to heat an article, garment, or towel to a pre-selected temperature in a range of 135° F.-220° F. and maintain that pre-selected temperature for a pre-selected period of time in a range of 10 sec.-120 min. The towel rack can be further configured to cool the article, garment, or towel to a temperature which is less than the pre-selected temperature.

According to a second aspect of the disclosed embodiments, a towel rack includes a first section. The first section includes a plurality of first section cross bars coupled thereto and wherein each of the plurality of first section cross bars comprise a first section cross bar conduit. At least one first section vent is provided. The at least one first section vent traverses the first section cross bar conduit of at least one of the plurality of first section cross bars. A second section is provided. The second section includes a plurality of second section cross bars coupled thereto and wherein each of the plurality of second section cross bars comprise a second section cross bar conduit. At least one second section vent is provided. The at least one second section vent traverses the second section cross bar conduit of at least one of the plurality of second section cross bars. A plurality of lateral supports is provided. The first section and the second section are fluidly connected via the plurality of lateral supports. At least one forced air unit is in fluid communication with a channel within the plurality of lateral supports. The channel within the plurality of lateral supports is in fluid communication with the at least one first section vent, the at least one second section vent, or combinations thereof. The second section cross bar conduit is larger than the first section cross bar conduit.

In some embodiments of the second aspect, at least one heating element and a controller can be provided. The at least one forced air unit can include an air moving component. The controller can be operatively coupled to the at least one heating element and the air moving component to control air temperature and flow through the at least one vent. The at least one heating element can be located in the at least one forced air unit. The at least one heating element can be located in at least one of the plurality of lateral supports. The at least one heating element can be located in the first section. The at least one heating element can be located in the second section. The plurality of lateral supports can include a first lateral support and a second lateral support. The at least one forced air unit can be coupled to the first lateral support. At least one stopper can be obstructively positioned within the conduit proximal to the second lateral support. A plurality of stoppers can be obstructively positioned within at least one first section cross bar conduit, at least one second section cross bar conduit, or combinations thereof, and proximal to the second lateral support. An attachable aroma therapy element can be provided including a clip, a housing, at least one slot, and a scented compound. The scented compound can be positioned within the housing. The at least one slot can traverses the housing. The attachable aroma therapy element can be coupled to at least one of the plurality of first section cross bars or to at least one of the plurality of first section cross bars adjacent to at least one first section vent or at least one second section vent by way of the clip. The at least one slot can be operatively aligned with the at least one first section vent or the at least one second section vent. At least two of the plurality of first section cross bars can include at least one first section vent, at least two of the plurality of second section cross bars can include at least one second section vent, or combinations thereof.

According to a third aspect of the disclosed embodiments, a method for assembling a towel drying rack includes connecting one or more lateral supports to a plurality of cross bars. A first portion of the plurality of cross bars constitutes a first section of the towel drying rack. A second portion of the plurality of cross bars constitutes a second section of the towel drying rack. A second section cross bar conduit is larger than a first section cross bar conduit. The method also includes fluidly connecting a channel within at least one of the lateral supports to at least one first section cross bar conduit and at least one second section cross bar conduit. The method also includes fluidly connecting at least one vent formed into at least one of the plurality of cross bars to at least one first section cross bar conduit or at least one second section cross bar conduit. The method also includes fluidly connecting a forced air unit to at least one of the channel within at least one of the lateral supports, at least one first section cross bar conduit, and at least one second section cross bar conduit.

In some embodiments of the third aspect, the method can also include directing airflow, by the forced air unit, into the channel within the at least one of the lateral supports. The method can also include directing airflow from the channel into the at least one first section cross bar conduit, the at least one second section cross bar conduit, or combinations thereof. The method can also include directing airflow from the at least one first section cross bar conduit, the at least one second section cross bar conduit, or combinations thereof out of the at least one vent formed into at least one of the plurality of cross bars toward a towel or garment. The method can also include fluidly connecting one or more heating elements to one or more of the forced air unit, each conduit of the plurality of cross bars, and the channel. The method can also include heating airflow generated by the forced air unit before the airflow exits the at least one vent formed into at least one of the plurality of cross bars. The method can also include connecting a controller to one or more of the elements of the towel drying rack; and manually or remotely controlling the operation of the towel drying rack via the controller. The method can also include attaching an aroma therapy element over at least one vent formed into the at least one of the plurality of cross bars.

According to a fourth aspect of the disclosed embodiments, a garment drying rack includes at least one lateral support comprising a channel within an interior of the lateral support. At least one forced air unit is in fluid communication with the channel and configured to generate airflow into the channel. A plurality of cross bars is provided. Each of the plurality of cross bars includes a conduit positioned within an interior of each of the plurality of cross bars. The conduit of each of the plurality of cross bars is in fluid communication with the channel. A first portion of the plurality of cross bars constitutes a first section of the garment drying rack. A second portion of the plurality of cross bars constitutes a second section of the garment drying rack. A second section cross bar conduit is larger than a first section cross bar conduit. A plurality of vents is provided. At least a first vent of the plurality of vents is in fluid communication with a first conduit of one of the plurality of cross bars and at least a second vent of the plurality of vents is in fluid communication with a second conduit of one of the plurality of cross bars.

In some embodiments of the fourth aspect, one or more heating elements can be provided in fluid communication with one or more of the forced air unit. The conduit can be positioned within the interior of each of the plurality of cross bars, and the channel. The one or more heating elements can be configured to heat the airflow before it exits the plurality of vents. At least one aroma therapy element can be positioned over at least one of the plurality of vents configured to provide a scent that is spread via the airflow exiting the at least one of the plurality of vents.

In some embodiments, a method is provided for heating an article, garment, or towel to a pre-selected temperature in a range of 135° F.-220° F. and maintaining that pre-selected temperature for a pre-selected period of time in a range of 10 sec.-120 min. The heating can be sufficient to kill a pathogen, germ, bacterium, a virus, or combinations thereof. The article, garment, or towel can be in contact with a towel rack as disclosed herein. The article, garment, or towel can be in contact with a garment drying rack as described herein. The method can include cooling the article, garment, or towel to a temperature which is less than the pre-selected temperature.

The towel racks described herein can be configured to heat an article, garment, or towel to a pre-selected temperature in a range of 135° F.-220° F. and maintain that pre-selected temperature for a pre-selected period of time in a range of 10 sec.-120 min. The heating can be sufficient to kill a pathogen, germ, bacterium, a virus, or combinations thereof. The towel racks described herein can be configured to cool the article, garment, or towel to a temperature which is less than the pre-selected temperature.

The garment drying racks described herein can be configured to heat an article, garment, or towel to a pre-selected temperature in a range of 135° F.-220° F. and maintain that pre-selected temperature for a pre-selected period of time in a range of 10 sec.-120 min. The heating can be sufficient to kill a pathogen, germ, bacterium, a virus, or combinations thereof. The garment drying racks described herein can be configured to cool the article, garment, or towel to a temperature which is less than the pre-selected temperature.

According to a fifth aspect of the disclosed embodiments, a towel rack includes a base. A first lateral sidewall extends from the base. A second lateral sidewall extends from the base. Ends of the first lateral sidewall and ends of the second lateral sidewall are configured to form a space between the first lateral sidewall and the second lateral sidewall. At least one of the first lateral sidewall and the second lateral sidewall are configured to provide a fluid flow path which traverses the respective first lateral sidewall and second lateral sidewall. A forced air unit is provided. A heating element heats air which is moved via the forced air unit through the fluid flow path. An internal vent is located in the at least one of the first lateral sidewall and the second lateral sidewall and is in fluid communication with the fluid flow path and configured to emit the air into the space. The first lateral sidewall, the second lateral sidewall, or a combination thereof, is configured to support at least one towel.

In some embodiments of the fifth aspect, the first lateral sidewall can be configured to support a first towel. The second lateral sidewall can be configured to support a second towel. The ends of the first lateral sidewall can be coupled to the ends of the second lateral sidewall. The forced air unit can be located in the base. The first towel and the second towel can be dried by the air emitted into the space. The first towel and the second towel can be heated by the air emitted into the space. The first towel and the second towel can be cooled by the air emitted into the space.

Optionally, in the fifth aspect, an external vent can be located in an outer surface of the first lateral sidewall. The internal vent can be configured to emit air toward a portion of the at least one towel located in the space. The external vent can be configured to emit air toward a portion of the at least one towel that is located adjacent the outer surface of the first lateral sidewall. The at least one towel can be dried by the air emitted by the external vent. The at least one towel can be heated by the air emitted by the external vent. The at least one towel can be cooled by the air emitted by the external vent.

It may be desired, in the fifth aspect, that an external vent is located in an outer surface of the second lateral sidewall. The internal vent can be configured to emit air toward a portion of the at least one towel located in the space. The external vent can be configured to emit air toward a portion of the at least one towel that is located adjacent the outer surface of the second lateral sidewall. The at least one towel can be dried by the air emitted by the external vent. The at least one towel can be heated by the air emitted by the external vent. The at least one towel can be cooled by the air emitted by the external vent.

It may be contemplated, in the fifth aspect, that a first external vent is located in an outer surface of the first lateral sidewall. A second external vent can be located in an outer surface of the second lateral sidewall. The internal vent can be configured to emit air toward portions of a first towel and a second towel located in the space. The first external vent can be configured to emit air toward a portion of the first towel that is located adjacent the outer surface of the first lateral sidewall. The second external vent can be configured to emit air toward a portion of the second towel that is located adjacent the outer surface of the second lateral sidewall. The first towel and the second towel can be dried by the air emitted into the space. The first towel can be dried by the air emitted by the first external vent. The second towel can be dried by the air emitted by the second external vent. The first towel and the second towel can be heated by the air emitted into the space. The first towel can be heated by the air emitted by the first external vent. The second towel can be heated by the air emitted by the second external vent. The first towel and the second towel can be cooled by the air emitted into the space. The first towel can be cooled by the air emitted by the first external vent. The second towel can be cooled by the air emitted by the second external vent.

In some embodiments of the fifth aspect, a base vent can be located in the base and configured to emit air upward into the space. The first lateral sidewall and the second lateral sidewall can be not integrally formed. A first lateral support can be provided. A first end of the first lateral sidewall can be coupled to a first end of the second lateral sidewall by the first lateral support. A second lateral support can be provided. A second end of the first lateral sidewall can be coupled to a second end of the second lateral sidewall by the second lateral support. The first lateral sidewall and the second lateral sidewall can form a cylinder extending from the base. The first lateral sidewall and the second lateral sidewall can form an elongated oval extending from the base. The first lateral sidewall and the second lateral sidewall can form an elongated rectangle extending from the base. At least one of the first lateral sidewall and the second lateral sidewall can include a solid wall extending between a top and the base.

Optionally, in the fifth aspect, at least one of the first lateral sidewall and the second lateral sidewall can include sidewall segments that are spaced apart between a top and the base. Both of the first lateral sidewall and the second lateral sidewall can include sidewall segments that are spaced apart between a top and the base. Each of the sidewall segments can be equally spaced apart between the top and the base. Each of the sidewall segments can have the same thickness. At least two of the sidewall segments can have a different thickness. A thickness of the sidewall segments can increase from the base to the top. A thickness of the sidewall segments can decrease from the base to the top. Each of the sidewall segments can have the same height. At least two of the sidewall segments can have a different height. A height of the sidewall segments can increase from the base to the top. A height of the sidewall segments can decrease from the base to the top. At least one of the sidewall segments can include an internal vent. Each of the sidewall segments can include an internal vent. At least one of the sidewall segments can include an external vent located in an outer surface of the sidewall segment. Each of the sidewall segments can include an external vent located in an outer surface of the sidewall segment.

In some embodiments of the fifth aspect, at least one of the first lateral sidewall and the second lateral sidewall can include a top vent located in a top surface of the respective first lateral sidewall and second lateral sidewall. A thickness of the first lateral sidewall and the second lateral sidewall can increase from the base to the top. A thickness of the first lateral sidewall and the second lateral sidewall can decrease from the base to the top. An aromatherapy cartridge can be in fluid communication with the fluid flow path so that the air emitted from the vent is mixed with aromatherapy particles from the aromatherapy cartridge. The towel rack can be configured to kill a pathogen, germ, bacterium, a virus, or combinations thereof.

According to a sixth aspect of the disclosed embodiments, a towel rack includes a first lateral support and a second lateral support. A cross structure extends between the first lateral support and the second lateral support. At least one of the cross structure, the first lateral support, and the second lateral support is configured to provide a fluid flow path which traverses at least one of the cross structure, the first lateral support, and the second lateral support. A forced air unit is provided. A heating element heats air which is moved via the forced air unit through the fluid flow path. A vent is located in at least one of the cross structure, the first lateral support, and the second lateral support and is in fluid communication with the fluid flow path. The cross structure, the first lateral support, and the second lateral support are further configured to support a towel and cause the towel to form a space which receives air which emitted from the vent.

In some embodiments of the sixth aspect, the vent can be configured to emit the air toward a portion of the towel. The cross structure can include a lower cross structure and an upper cross structure. The vent can be located in the lower cross structure and configured to emit the air in any direction. The vent can be located in the upper cross structure and configured to emit the air in any direction. A vent can be located in two of the lower cross structure, the upper cross structure, the first lateral support, and the second lateral support. A vent can be located in three of the lower cross structure, the upper cross structure, the first lateral support, and the second lateral support. A vent can be located in each of the lower cross structure, the upper cross structure, the first lateral support, and the second lateral support. A lower cross structure vent can be located in the lower cross structure and configured to emit air in any direction. An upper cross structure vent can be located in the upper cross structure and configured to emit air in any direction. A first lateral support vent can be located in the first lateral support and configured to emit air in any direction. A second lateral support vent can be located in the second lateral support and configured to emit air in any direction.

Optionally, in the sixth aspect, at least one of the lower cross structure and the upper cross structure can include a first vent configured to emit air in any direction. A second vent can be configured to emit air toward the towel. The second vent can be located on at least one of a front and back of the at least one of the lower cross structure and the upper cross structure. The first vent can be located on at least one of a top and bottom of the at least one of the lower cross structure and the upper cross structure.

It may be desired, in the sixth aspect, that the lower cross structure is differently sized from the upper cross structure. A plurality of intermediate cross structures can extend between the first lateral support and the second lateral support between the lower cross structure and the upper cross structure. The lower cross structure can have a diameter that is different than a diameter of the upper cross structure. Each of the plurality of intermediate cross structures can have a different diameter. The diameter of the each of the plurality of intermediate cross structures can be different than the diameter of the lower cross structure and the diameter of the upper cross structure. The diameter of each of the plurality of intermediate cross structures can increase when moving from the lower cross structure to the upper cross structure. The diameter of each of the plurality of intermediate cross structures can decrease when moving from the lower cross structure to the upper cross structure.

It may be contemplated, in the sixth aspect, that a plurality of intermediate lateral supports extends between the lower cross structure and the upper cross structure between the first lateral support and the second lateral support. The cross structure can be formed in a lattice configuration.

In some embodiments of the sixth aspect a base is provided. The first lateral support and the second lateral support can extend from the base. The cross structure can be formed integrally with the first lateral support and the second lateral support as a panel and the cross structure can extend from the base. The cross structure can house the forced air unit and the heating element. The base can house the forced air unit and the heating element. The forced air unit and the heating element can be housed in one of the first lateral support and the second lateral support.

Optionally, in the sixth aspect, the space can be configured to be at least partially sealed when a towel is supported by the cross structure, the first lateral support, and the second lateral support. The air emitted into the space can be configured to be at least partially trapped by the towel when a towel is supported by the cross structure, the first lateral support, and the second lateral support.

It may be desired, the sixth aspect, that the cross structure includes a front panel and a back panel extending from the cross structure to support the towel. The front panel can extend at an angle relative to the back panel. At least one of the front panel and the back panel can extend parallel to a vertical axis. At least one of the front panel and the back panel can extend at an oblique angle to a vertical axis. At least one of the front panel and the back panel can have an adjustable length along an axis of the cross structure. The front panel can include a first front panel located adjacent the first lateral support. A second front panel can be located adjacent the second lateral support. The back panel can include a first back panel located adjacent the first lateral support. A second back panel can be located adjacent the second lateral support. At least one of the front panel and the back panel can extend an entire length of the cross structure. A plurality of cross structures can extend between the first lateral support and the second lateral support. Each of the plurality of cross structures can include a respective front panel and back panel.

In some embodiments of the sixth aspect, an aromatherapy cartridge can be in fluid communication with the fluid flow path so that the air emitted from the vent is mixed with aromatherapy particles from the aromatherapy cartridge. The towel rack can be configured to kill a pathogen, germ, bacterium, a virus, or combinations thereof.

Optionally, in the sixth aspect, a horizontally moveable slat can slide along the cross structure to facilitate increasing heat capture. The cross structure can be formed integrally with the first lateral support and the second lateral support as a panel.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 illustrates a perspective view of a heated towel rack with a towel, in accordance with one embodiment;

FIG. 2 illustrates a front view of the heated towel rack in accordance with one embodiment;

FIG. 3 illustrates an isometric view of the heated towel rack in accordance with one embodiment;

FIG. 4 illustrates a partial sectional view of the heated towel rack in accordance with one embodiment;

FIG. 5 illustrates a sectional view of the heated towel rack in accordance with one embodiment;

FIG. 6 illustrates a partial isometric view of the heated towel rack in accordance with one embodiment;

FIG. 7 illustrates a partial isometric view of the heated towel rack in accordance with one embodiment;

FIG. 8 illustrates a perspective view of an attachable aroma therapy element in accordance with one embodiment;

FIG. 9 illustrates a perspective view of a heated towel rack in accordance with one embodiment;

FIG. 10 is a front perspective view of a towel rack formed in accordance with an embodiment;

FIG. 11 is a rear perspective view of the towel rack shown in FIG. 10;

FIG. 12 is a front perspective view of the towel rack shown in FIG. 10 and illustrating various locations of an air unit and a heating element in accordance with an embodiment;

FIG. 13 is a front perspective view of the towel rack shown in FIG. 10 and having a first towel and a second towel positioned thereon;

FIG. 14 is a front perspective view of the towel rack shown in FIG. 10 and having the first towel tucked into a lower lip of the towel rack;

FIG. 15 is a front perspective view of an embodiment of the towel rack shown in FIG. 10 having a sidewall that narrows from a base to a top;

FIG. 16 is a front perspective view of an embodiment of the towel rack shown in FIG. 10 having a sidewall that narrows from the top base to the base;

FIG. 17 is a front perspective view of an embodiment of an oval towel rack formed in accordance with an embodiment;

FIG. 18 is a front perspective view of an embodiment of a rectangular towel rack formed in accordance with an embodiment;

FIG. 19 is a front perspective view of an embodiment of a towel rack having a pair of lateral sidewalls coupled to lateral supports;

FIG. 20 is a front perspective view of an embodiment of a towel rack having a plurality of spaced apart sidewall segments;

FIG. 21 is a front perspective view of the towel rack of FIG. 19 including an aromatherapy cartridge;

FIG. 22 is a front perspective view of a towel rack formed in accordance with an embodiment;

FIG. 23 is a rear perspective view of the towel rack shown in FIG. 22;

FIG. 24 is a front perspective view of the towel rack shown in FIG. 22 and having a towel positioned thereon;

FIG. 25 is a front perspective view of the towel rack shown in FIG. 22 and having a towel clipped to a pair of lateral supports;

FIG. 26 is a front perspective view of the towel rack shown in FIG. 22 and having a towel secured in grooves of lateral supports;

FIG. 27 is a front perspective view of the towel rack shown in FIG. 22 and illustrating various locations of a forced air unit and a heating element;

FIG. 28 is a front perspective view of the towel rack shown in FIG. 22 and having a base;

FIG. 29 is a front perspective view of another towel rack in accordance with an embodiment and having a plurality of cross structures;

FIG. 30 is a front perspective view of the towel rack shown in FIG. 22, wherein the cross structures include front and back panels;

FIG. 31 is a rear perspective view of the towel rack shown in FIG. 30;

FIG. 32 is a side cross-sectional view of the towel rack taken about line 32-32 shown in FIG. 30;

FIG. 33 is a front perspective view of yet another towel rack in accordance with an embodiment and having a plurality of cross structures with different diameters;

FIG. 34 is a front perspective view of the towel rack shown in FIG. 33, wherein the cross structures include front and back panels;

FIG. 35 is a rear perspective view of the towel rack shown in FIG. 34;

FIG. 36 is a side cross-sectional view of the towel rack taken about line 36-36 shown in FIG. 34;

FIG. 37 is a front elevation view of another towel rack in accordance with an embodiment and having a plurality of lateral supports;

FIG. 38 is a front elevation view of another towel rack in accordance with an embodiment and having a plurality of cross structures and a plurality of lateral supports that form a lattice;

FIG. 39 is a front elevation view of the towel rack of FIG. 29 having a slat that horizontally moves to seal the space formed by the towel;

FIG. 40 is a front elevation view of the towel rack of FIG. 22 including an aromatherapy cartridge; and

FIG. 41 is a front elevation view of another embodiment of a towel rack, wherein a cross structure is formed integrally with lateral supports to form a panel

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In an embodiment of the disclosure, a heated towel rack is provided as an apparatus for heating and/or drying towels. The heated towel rack may comprise a plurality of cross bars vertically arranged between one or more lateral support structures that serve as the racks a user on which a user may be able to hang a towel or other garment. At least one cross bar of the plurality of cross bars may include at least one vent configured to evenly distribute heated (or non-heated) air to the towel or garment, allowing the towel or garment to be evenly warmed and/or dried. In some embodiments, a plurality of cross bars may comprise a plurality of vents.

In some embodiments, a heated towel rack may include one or more (in some embodiments, two) lateral supports, at least one forced air heating unit in fluid communication with at least one channel within a lateral support, and a plurality of cross bars coupled between the one or more lateral supports. At least one cross bar of the plurality of cross bars may include at least one vent that traverses into a conduit within the cross bar. The channel of the lateral support may be in fluid communication with the at least one vent by way of the conduit of the cross bar. In some configurations, the at least one cross bar may be rotatably coupled with the at least one lateral support. The rotatable coupling between the cross bar(s) and the lateral support(s) would allow for the rotation of individual cross bars allowing a user to direct the angle of the vent(s) in order to redirect forced heated air to their liking.

In some embodiments, the at least one forced air heating unit may include at least one heating element, a fan, and a controller. The controller may be operatively coupled to the at least one heating element and the fan in order to control air temperature and airflow through the vent(s).

In some embodiments, the heated towel rack may include a first lateral support and a second lateral support. The first lateral support and the second lateral support may be differentiated by the attachment of the forced air heating unit. For example, the first lateral support may be coupled to at least one forced air heating unit, while the second lateral support may lack any direct coupling to a forced air heating unit. In alternative embodiments, the at least one forced air heating unit may not be coupled to a lateral support and may be coupled to a support cross bar that is in fluid communication with the at least one cross bar. In some embodiments, the heated towel rack may include a stopper that is obstructively positioned within the conduit proximal to the second lateral support to prevent heated air to enter the channel of the second lateral support. In some embodiments, the conduit may taper towards the first lateral support, such that the width of the conduit as it approaches the second lateral support is wider than the width of the conduit near the first lateral support.

In some embodiments, the heated towel rack may be configured with at least two lateral supports that comprise a first section and a second section. The first section may be proximal to the at least one forced air heating unit. The second section may be distal to the at least one forced air heating unit. The conduits of the plurality of cross bars in the second section may be larger than plurality of vents in the first section to evenly distribute the airflow through the towel rack.

In some embodiments, the heated towel rack may include an attachable aroma therapy element comprising one or more of: a clip, a housing, at least one slot, and/or a scented compound. The scented compound may be positioned within the housing. The at least one slot may traverse through the housing. The attachable aroma therapy element may be configured to couple to a cross bar adjacent to a vent. The at least one slot may be operatively aligned with the vent in order to allow the scented compound to enter into the surrounding environment via the airflow directed out of the vent and therefore through the housing of the aroma therapy element.

In some embodiments, the heated towel rack may be configured with the at least one cross bar having a cylindrical shape (profile). Alternatively, the heated towel rack may be configured with the at least one cross bar having a rectangular shape (profile). In some embodiments, the heated towel rack may be configured with a plurality of cross bars having similar or dissimilar shapes for each of the cross bars, where a portion of the cross bars may be differently shaped than another portion of the cross bars.

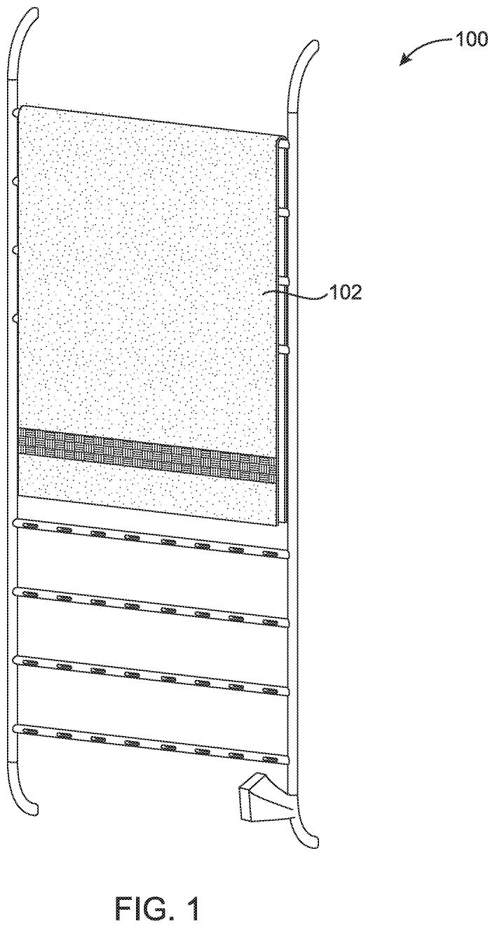

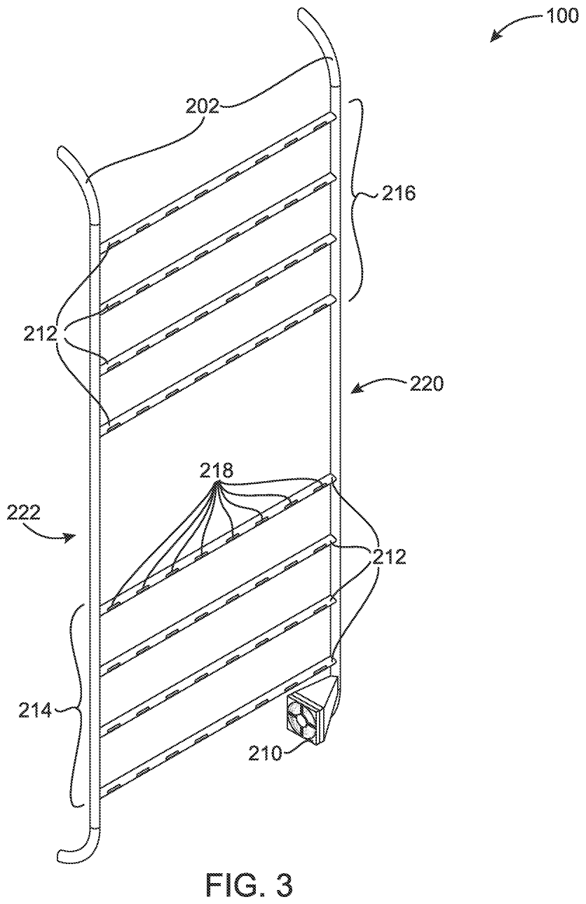

Referencing FIGS. 1-5, a heated towel rack 100 is an apparatus for drying and/or warming towels. A towel 102 placed on the rack receives heated air forced through a plurality of vents that help dry and heat a towel to a comfortable temperature. The heated towel rack 100 is configured to be mounted or attached to a surface (for example a counter or a wall), but alternative configurations may be provided that allow the towel rack to be a standing structure on the ground. The attachment to a wall may comprise adhesive, physical connectors, screws, nails, slots, and/or other connecting elements. In other embodiments, the towel rack may be freestanding and may function without being attached to a surface or wall.

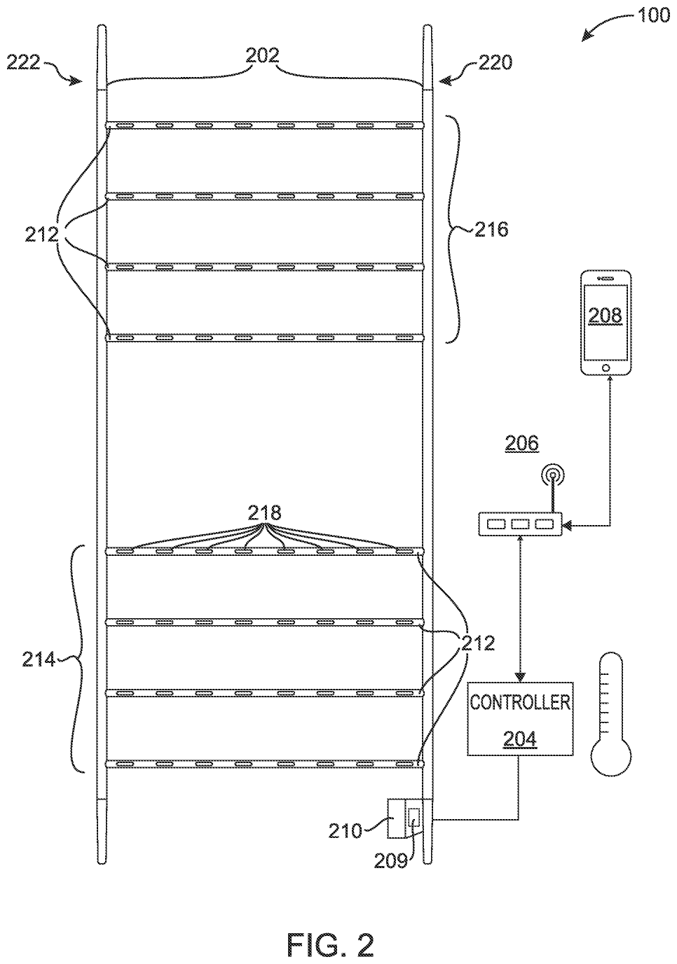

Referring to FIG. 2, the heated towel rack 100 comprises an at least two lateral supports 202, a forced air heating unit 210, and a plurality of cross bars 212. The at least two lateral supports 202 are positioned parallel to one another and provide a support structure for the heated towel rack 100. In some embodiments, the lateral supports 202 may not be aligned parallel and may form a “V” shape and/or “A” shape. In some embodiments, the at least two lateral supports may be individually referenced as a first lateral support 220 and a second lateral support 222. In some embodiments, the towel rack 100 may only comprise a single lateral support.

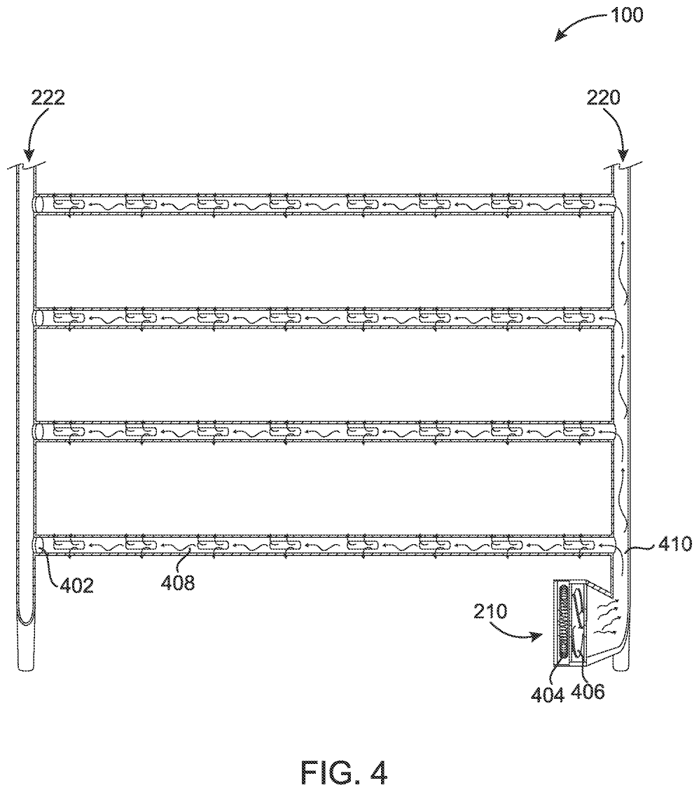

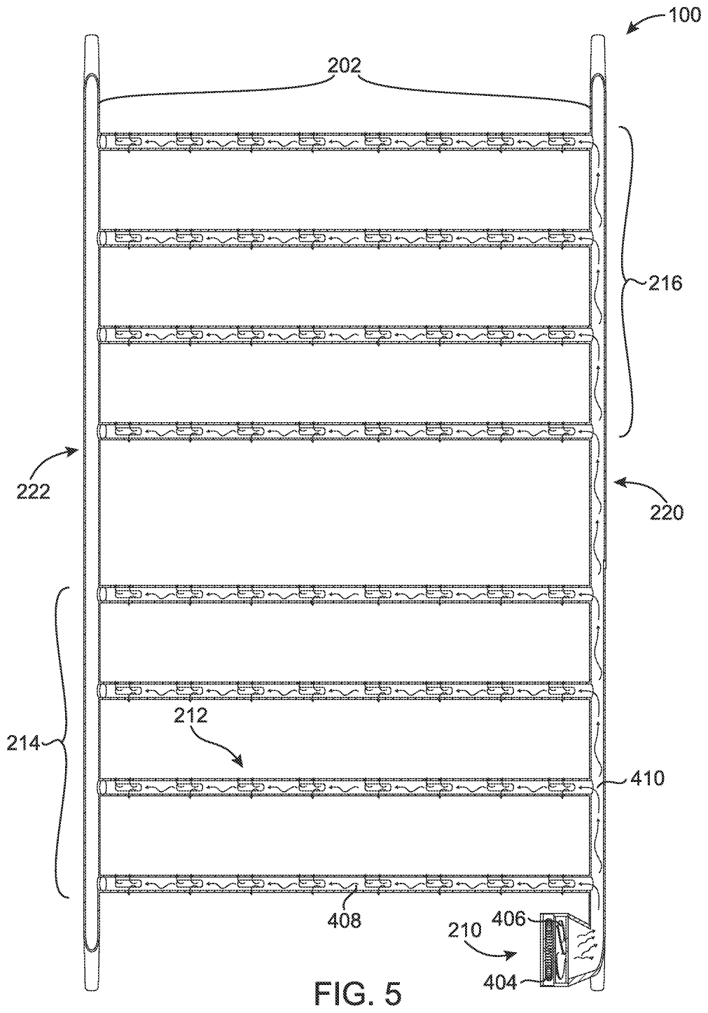

As shown in FIG. 4, the at least two lateral supports 202 include a channel 410 that is in fluid communication with the forced air heating unit 210 and the plurality of cross bars 212. The plurality of cross bars 212 are coupled between the at least two lateral supports 202. Each cross bar of the plurality of cross bars 212 include a conduit 408 that is in fluid communication with the channel 410 of at least one lateral support of the at least two lateral supports 202. Each cross bar of the plurality of cross bars 212 include at least one vent 218 that traverses into the conduit 408. In some embodiments, the cross bar 212 may comprise a plurality of vents, while in other embodiments, the cross bar 212 may comprise a single vent 218 that may extend over a portion of the cross bar 212. The vent(s) 218 act as an exhaust point for heated air from the forced air heating unit 210. The forced air heating unit 210 generates heat and forces air through the channel 410 at least one of the lateral supports 202 and through the vents 218 by way of the conduit 408. FIG. 5 illustrates an exemplary embodiment where the airflow may be directed only through the first lateral support 220, while in other embodiments the airflow could be present in (or directed through) the second lateral support 222 and/or both the first lateral support 220 and the second lateral support 222.

The forced air heating unit 210 forces heated air through the heated towel rack 100. In some configurations, the forced air heating unit 210 may comprise a fan 406 and a heating element 404. The fan 406 creates the air movement for forcing or directing heated air through the channel 410 of a lateral support of the at least two lateral supports 202. The heating element 404 generates heat raising the temperature of the surrounding air that is forced through the heated towel rack 100. In some configurations, the fan 406 may be positioned between the heating element 404 and the channel 410. In alternative configurations, the heating element 404 may be positioned between the fan 406 and the channel 410.

As shown in FIG. 2, the forced air heating unit 210 may be operated utilizing a controller 204 communicating with a user device 208 by way of a wireless communication module 206. A user may operate a user interface through the user device 208 to communicate control signals for changing the temperature and volume of air being pushed out through the plurality of vents 218. The control signals would be received by the controller 204 through a wireless communication module 206 to control the temperature settings of the heating element 404 and the speed of the fan 406. The wireless communication module 206 may communicate wirelessly with the user device 208 through any wireless communications technology including, but not limited to WiFi, near field communications (NFC), Bluetooth, mobile communications standards (e.g., Long Term Evolution (LTE), etc.,), and etc. In some configurations, the controller 204 may be accomplished by an electro-mechanical switch that turns the device on/off. The electro-mechanical switch may additionally incorporate a timer mechanism and/or a temperature sensor to control when the forced air heating unit 210 turns on or off. In some embodiments, the controller 204 may be operated via a remote control configured to communicate with the controller 204 via a wireless connection, such as infrared (IR), radio frequency (RF), or another wireless connection. In some embodiments, the controller 204 may be operated via manual manipulation and/or remote manipulation using any of the above described methods.

In some embodiments, the controller 204 may comprise an input for the user to control the temperature of the air that is directed into the towel rack 100 via the forced air heating unit 210. In some embodiments, the heating element 404 may be optionally activated or not activated with the fan 406, depending on if the user wishes for the air directed out of the vents 218 to be heated or room temperature. In some embodiments, the heating element 404 may comprise multiple heat settings, where a user may choose one of a plurality of heat settings via the controller 204 and/or communication with the controller 204.

In some embodiments, the towel rack 100 may comprise a power source 209 configured to power the other elements of the towel rack 100. For example, the power source 209 may comprise battery power, where one or more battery may be connected to a part of the towel rack 100 and in communication with the controller 204 and/or the forced air heating unit 210. The power source 209 may also comprise corded, plug-in, or hard-wired power, where a cord may be connected to a part of the towel rack 100 and in communication with the controller 204 and/or the forced air heating unit 210.

In some configurations, more than one forced air heating unit 210 may be utilized in the heated towel rack. In a two unit arrangement, one forced air heating unit may be positioned on the lower portion of one lateral support, while the other forced air heating unit may be positioned the opposite end of the neighboring lateral support. Alternatively, one or more fans may be positioned on (or within) one or more support cross bar (which may be parallel to cross bars and attached to the lateral supports). In some embodiments, the towel rack may comprise two or more fans positioned on the support cross bars, where each of the multiple fans may direct airflow to only a portion of the cross bars and vents. For example, a first fan may provide airflow to an upper portion of the towel rack (and may be positioned on the upper portion of the towel rack), and a second fan may provide airflow to a lower portion of the towel rack (and may be position on the lower portion of the towel rack).

In some configurations, the forced air heating unit 210 may include more than one heating element 404. In some embodiments, the heating element(s) 404 may be positioned within the conduit 408 and/or within the channel 410 and may be utilized in addition to or as an alternative to the single heating unit configurations that have been previously described. In some embodiments, the fan 406 of the forced air heating unit 210, and/or the entire forced air heating unit 210, may be positioned anywhere on the towel rack 100 that is in fluid communication with the channel 410, the conduit 408, and/or the vents 218. For example, the forced air heating unit 210 may be positioned on one of the support cross bars (described above), wherein the support cross bar(s) may comprise a channel within the support cross bar to provide fluid communication between the forced air heating unit 210 and the rest of the towel rack (i.e., the conduit, channels, and/or vents).

In some embodiments, the controller 204 may cause the forced air heating unit 210 and/or the heating element(s) 404 to produce heat and/or heated air at a temperature in the range of 100° F.-220° F.

In some embodiments, the forced air heating unit 210 and/or the heating element(s) 404 may be configured to produce heat and/or heated air at a temperature which kills pathogens, germs, bacteria, and/or viruses. For example, components of the towel rack 100, e.g., the plurality of cross bars 212, the first lateral support 220, and the second lateral support 222, may be heated to temperatures in the range of 135° F.-220° F. In an embodiment, the plurality of cross bars 212, the first lateral support 220, and/or the second lateral support 222 may be heated to a temperature of 135° F., 140° F., 145° F., 150° F., 155° F., 160° F., 165° F. 170° F., 175° F., 180° F., 185° F., 190° F., 195° F., 200° F., 205° F., 210° F., 215° F., or 220° F. Accordingly, any article, garment, or towel which contacts a cross bar 212, the first lateral support 220, and/or the second lateral support 222 which has been heated to a temperature of 135° F., 140° F., 145° F., 150° F., 155° F., 160° F., 165° F., 170° F., 175° F., 180° F., 185° F. 190° F., 195° F., 200° F., 205° F., 210° F., 215° F., or 220° F. may have its temperature raised to a temperature which is the same or substantially the same as the heated cross bar 212, the heated first lateral support 220, and/or the heated second lateral support 222 via conduction and/or convection. Additionally and or alternatively, air which is emitted from the plurality of vents 218 may emitted at temperatures in the range of 135° F.-220° F. For example, air exiting any and/or all of the plurality of vents 218 may exit any and/or all vents 218 at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. Accordingly, any article, garment, or towel which contacts, or is in proximity to, any of the plurality of vents 218 emitting air at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. may have its temperature raised to a temperature which is the same or substantially the same as the air exiting any or all of the plurality of vents 218 via conduction and/or convection.

In an embodiment, controller 204 may execute a program to cause the towel rack 100 to heat an article, garment, or towel to a pre-selected temperature in a range of 135° F.-220° F. and to maintain (or prevent from falling below) that pre-selected temperature for a pre-selected period of time in a range of 10 sec.-120 min. In an embodiment, controller 204 may execute a program to cause the towel rack 100 to heat an article, garment, or towel to a pre-selected temperature, e.g., 185° F., and to maintain that pre-selected temperature for a pre-selected period of time, e.g. 40 minutes. The controller 204 may then execute a program (or another portion of a first program) to cool the article, garment, or towel down to a temperature below the pre-selected temperature (e.g., cool the article, garment, or towel from 185° F. to 110° F.).

In the example shown in FIGS. 2-5, the heated towel rack 100 is configured with a single forced air heating unit 210 positioned on the lower portion of a lateral support. The region proximal to the forced air heating unit 210 is considered the first section 214, while the region distal to the forced air heating unit 210 is considered the second section 216. Similarly, the lateral support coupled to the forced air heating unit 210 is considered the first lateral support 220, while the other lateral support is considered the second lateral support 222.

To help improve airflow from the forced air heating unit 210 through the channel 410 and subsequently the conduit 408 of the plurality of cross bars 212, the conduit 408 of the plurality of cross bars 212 in the second section 216 may be larger than the conduit 408 in the first section 214. Additionally, the plurality of vents 218 in the second section 216 may be larger than the plurality of vents 218 in the first section 214. Through changing the width of either, or in combination, the plurality of vents 218 of the conduit 408, the flow rate and temperature of heated air through the plurality of vents 218 may be consistent across all of the plurality of vents 218. In some embodiments, the number of vents 218 may be different in the first section 214 and the second section 216 to provide consistent airflow to all of the vents 218.

In some embodiments, one or more of the cross bars 212 may comprise vents 218 on the back side of the cross bar 212. In some embodiments, one or more of the cross bars 212 may comprise vents 218 on the front side and/or the back side of the cross bar 212. In some embodiments, one or more of the cross bars 212 may not comprise vents 218 while other cross bars 212 may comprise vents 218. Also, in some embodiments, some cross bars may comprise a greater number of vents than other cross bars.

The heated towel rack 100 may also incorporate at least one stopper 402 to help airflow through the conduit 408 of the plurality of cross bars 212. A stopper 402 is obstructively positioned within a cross bar 212 on the end of the cross bar 212 proximal to the second lateral support 222. In some embodiments, any number of the cross bars 212 may comprise a stopper 402. In some embodiments, one or more of the cross bars 212 may not comprise a stopper to allow for fluid communication between the channels 410 of the lateral supports 220 and 222. In some configurations, more than one forced air heating unit 210 may be incorporated into a heated towel rack, the stopper 402 may not be needed in these configurations. In some configurations, the stopper 402 may be utilized to block portions of the channel 410 within the lateral support that do not interface with the conduit 408. In some configurations, the conduit 408 may taper such that the width of the conduit 408 towards the second lateral support 222 is larger than the width of the conduit 408 proximal to the first lateral support 220.

In some embodiments, one or more elements of the towel rack 100 may comprise a metal material. In some embodiments, one or more elements of the towel rack 100 may comprise a plastic material, such as a thermoplastic, a polymer, and/or another plastic material. In some embodiments, one or more elements of the towel rack 100 may comprise a ceramic material. The material may be selected to prevent damage from heating by the heating elements of the forced air heating unit.

In some embodiments, the towel rack 100 may comprise snap fit components, wherein the towel rack 100 may ship in multiple pieces or components which may then be assembled by a customer. In some embodiments, a front surface or panel (i.e., that faces away from the wall when the towel rack 100 is install onto a wall) may be configured to be replaceable and may comprise a variety of colors or designs. In some embodiments, additional front surfaces or panels may be sold separately from the towel rack 100. This may be useful for a user who has installed the towel rack 100 in their bathroom or other room, and then changes the decorations or design of the room, and then wish to change the appearance of the towel rack 100 to coordinate with the new design.

In some embodiments, the towel rack 100 may be sized to fit or accommodate a particular size of towel or other garment. For example, the towel rack 100 may be sized to fit a bath sheet, a body towel, a hand towel, a washcloth, a robe, or another garment.

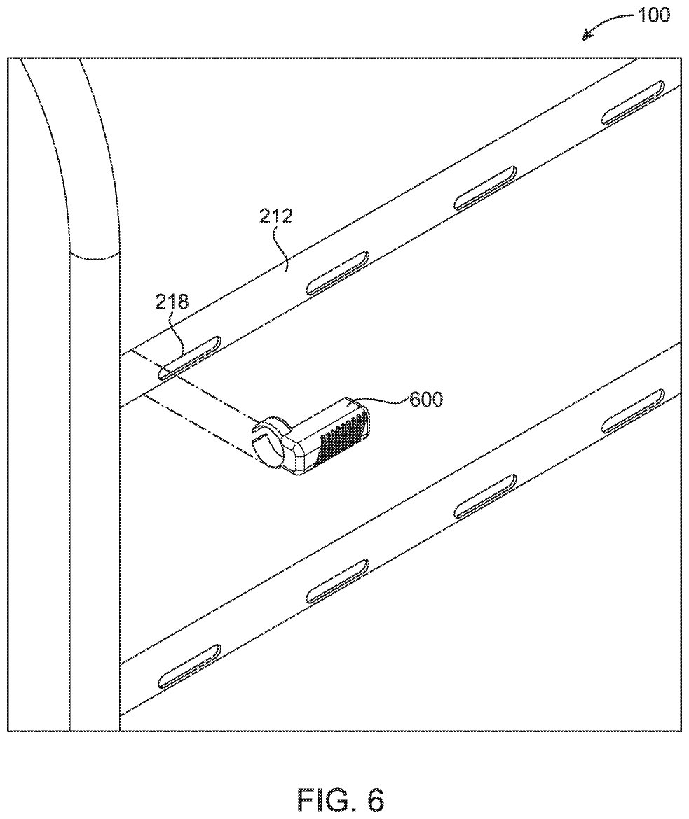

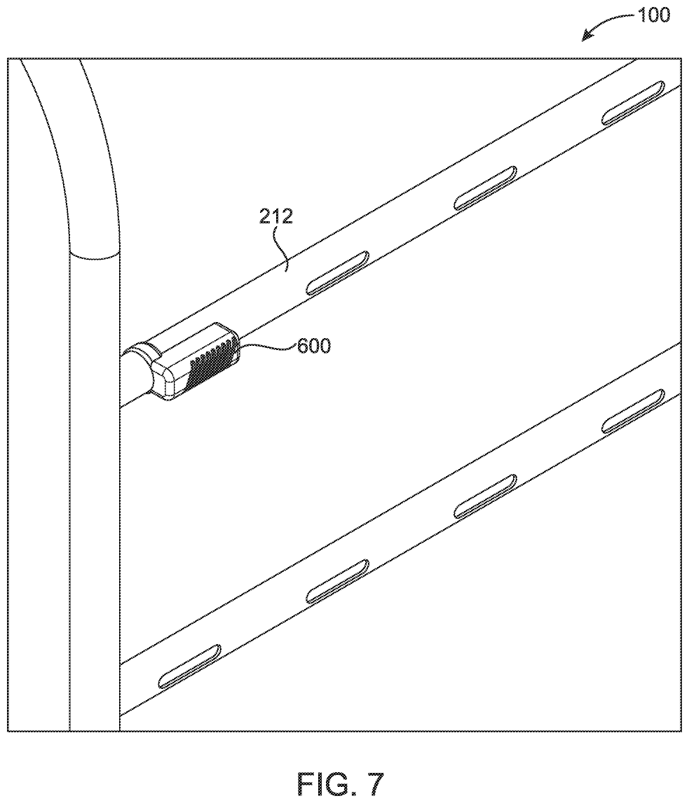

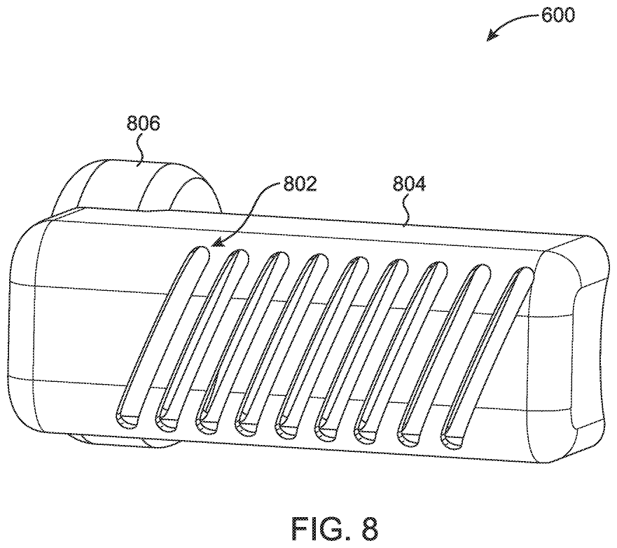

Referencing FIGS. 6-8, an attachable aroma therapy element 600 may couple over at least one vent 218 on a cross bar 212 of the heated towel rack 100 allowing a scented compound to be released with the heated air that exits the vent 218. As shown in FIG. 8, the attachable aroma therapy element 600 comprises a plurality of slots 802, a housing 804, and a clip 806. The plurality of slots 802 traverse through the housing 804 creating a passage for heated air to exit when the attachable aroma therapy element 600 is placed over a vent 218. In other words, the slots 802 may extend through to the back surface of the vent 218. The housing 804 holds the scented compound in place allowing heated air from the vent 218 to pass through the plurality of slots 802 and carrying the scented compound into the surrounding space. The scented compound may be configured as a disposable insert. The clip 806 functions as the attachment mechanism for securing the attachable aroma therapy element 600 to the cross bar 212. The clip 806 may couple to the cross bar 212 adjacent to the vent 218 to allow the plurality of slots 802 to align with the vent 218.

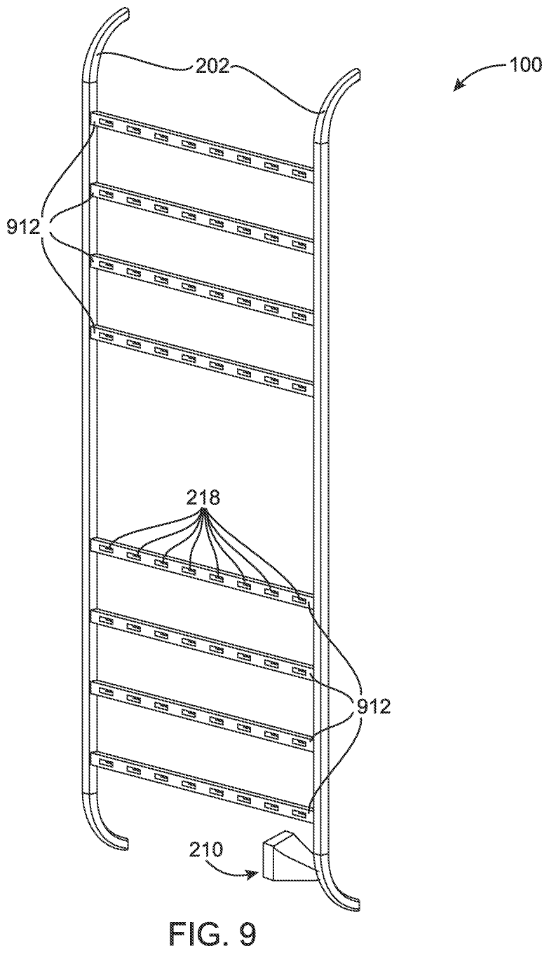

Referencing FIG. 9, a heated towel rack 900 is an alternative configuration of the heated towel rack 100 (as shown in FIG. 1) with the plurality of cross bars 912 being rectangularly shaped such that they have a rectangular profile. The heated towel rack 900 comprises a forced air heating unit 210, at least two lateral supports 202, and a plurality of cross bars 912. In the heated towel rack 100 shown in FIG. 1, the plurality of cross bars 212 are generally cylindrical in shape with the plurality of vents 218 having a semi elliptical profile. In the heated towel rack 900, the plurality of cross bars 912 of the heated towel rack 900 are rectangular in shape. The plurality of vents 218 of the plurality of cross bars 912 may have a rectangular profile. In some configurations, the plurality of vents 218 may have any shape profile (e.g., elliptical, tear drop, etc.) to vent the forced heated air.

The term “wireless communication” in this context refers to the transfer of information between two or more points that are not connected by an electrical conductor. Common wireless technologies use electromagnetic wireless telecommunications, such as radio. With radio waves distances can be short, such as a few meters for television, or as far as thousands or even millions of kilometers for deep-space radio communications. Wireless communication encompasses various types of fixed, mobile, and portable applications, including two-way radios, cellular telephones, personal digital assistants (PDAs), and wireless networking. Other examples of applications of radio wireless technology include GPS units, garage door openers, wireless computer mice, keyboards and headsets, headphones, radio receivers, satellite television, broadcast television and cordless telephones. Less common methods of achieving wireless communications include the use of light, sound, magnetic, or electric fields.

The term “user interface” in this context refers to logic to receive signals from device inputs such as a mouse, keyboard, or microphone, and to correlate those inputs with visual features rendered on an optical display. A user interface determines how a human operator interacts with and controls a device. User interfaces are comprised of elements with which the human operator interacts to affect device behavior. Examples of user interface elements are (1) command language (text): the operator inputs program-specific instructions or codes into the device, (2) menus: the operator selects elements from displayed lists, (3) buttons: the operator selects (typically by clicking the mouse cursor on) defined areas of the display.

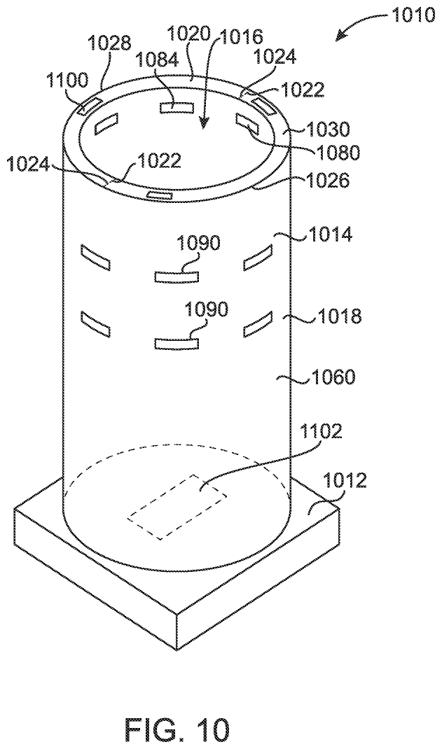

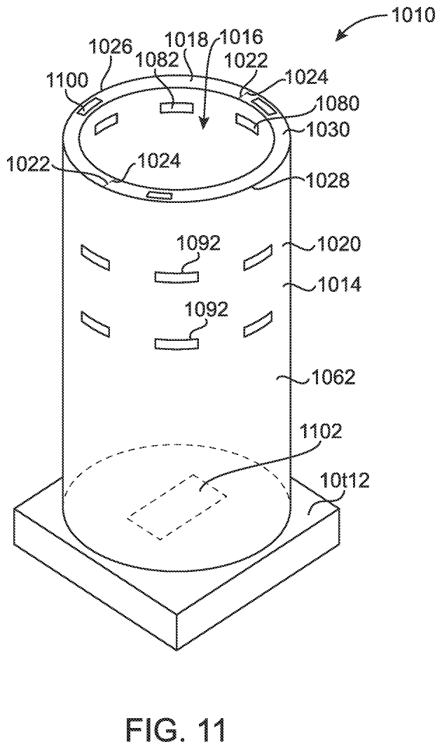

Referring to FIGS. 10 and 11, a towel rack 1010 includes a base 1012 and a lateral sidewall 1014 extending from the base 1012. The lateral side wall 1014 is configured to form an internal space 1016. The lateral sidewall 1014 includes a front lateral sidewall 1018 and a rear lateral sidewall 1020 that are coupled together to define the space 1016. That is, ends 1022 of the front lateral sidewall 1018 are joined to ends 1024 of the rear lateral sidewall 1020 so that an apex 1026 of the front lateral sidewall 1018 is positioned opposite an apex 1028 of the rear lateral sidewall 1020. In the illustrated embodiment, the front lateral sidewall 1018 and the rear lateral sidewall 1020 are integrally formed as a cylinder extending from the base 1012. At least one of the front lateral sidewall 1018 and the rear lateral sidewall 1020 is configured as a solid wall extending from the base 1012 to a top 1030 of the lateral sidewall 1014. In the illustrated embodiment, each of the front lateral sidewall 1018 and the rear lateral sidewall 1020 includes a solid wall extending from the base 1012 to the top 1030 of the lateral sidewall 1014. It will be appreciated that, as described below, at least one of the front lateral sidewall 1018 and the rear lateral sidewall 1020 can be formed in a non-solid configuration.

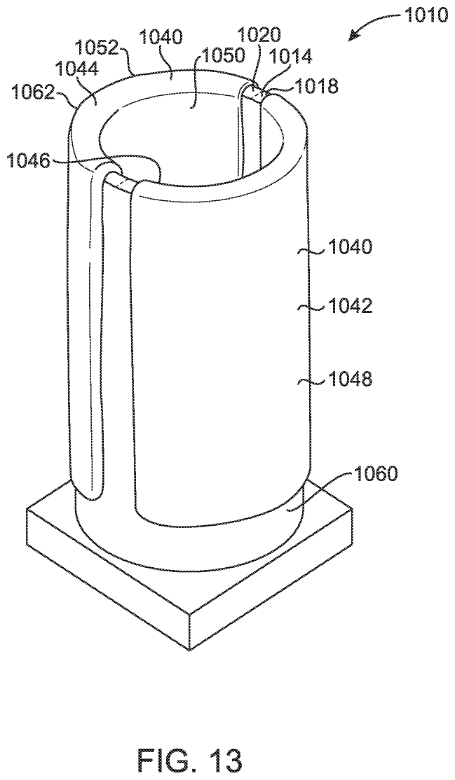

The lateral sidewall 1014 is configured to support at least one towel 1040, as shown in FIG. 13. That is, the front lateral sidewall 1018, the rear lateral sidewall 1020, or a combination thereof, is configured to support the at least one towel 1040. In the illustrated embodiment, the front lateral sidewall 1018 is configured to support a first towel 1042, and the rear lateral sidewall 1020 is configured to support a second towel 1044. A portion 1046 of the first towel 1042 is located in the space 1016, and another portion 1048 of the first towel 1042 is located adjacent an outer surface 1060 of the front lateral sidewall 1018. A portion 1050 of the second towel 1044 is located in the space 1016, and another portion 1052 of the second towel 1044 is located adjacent an outer surface 1062 of the rear lateral sidewall 1020.

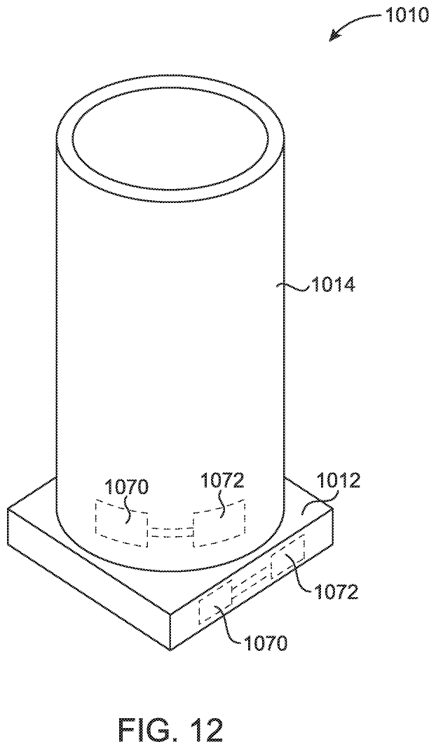

At least one of the front lateral sidewall 1018 and the rear lateral sidewall 1020 are configured to provide a fluid flow path which traverses the respective front lateral sidewall 1018 and rear lateral sidewall 1020. In some embodiments, the fluid flow path can also traverse through at least a portion of the base 1012. The fluid flow path is in fluid communication with a forced air unit 1070 that emits air through the fluid flow path. A heating element 1072 heats the air which is moved via the forced air unit 1070 through the fluid flow path. FIG. 12 illustrates various locations for positioning the forced air unit 1070 and the heating element 1072. In one embodiment, the forced air unit 1070 and the heating element 1072 are located in the base 1012. In another embodiment, the forced air unit 1070 and the heating element 1072 are located in the lateral sidewall 1014. In yet another embodiment, the forced air unit 1070 and the heating element 1072 are located in a combination of the base 1012 and the lateral sidewall 1014.

Referring back to FIGS. 10 and 11, at least one internal vent 1080 is located in the lateral sidewall 1014 and in fluid communication with the fluid flow path and configured to emit the air into the space 1016. In the illustrated embodiment, at least one front internal vent 1082 is located in the front lateral sidewall 1018, and at least one rear internal vent 1084 is located in the rear lateral sidewall 1020. The at least one front internal vent 1082 and the at least one rear internal vent 1084 is in fluid communication with the fluid flow path and configured to emit the air into the space 1016. At least one front external vent 1090 is located on the outer surface 1060 of the front lateral sidewall 1018 and is in fluid communication with the fluid flow path and configured to emit air toward the portion 48 of the first towel 1042 located adjacent an outer surface 1060 of the front lateral sidewall 1018. At least one rear external vent 1092 is located on the outer surface 1062 of the rear lateral sidewall 1020 and is in fluid communication with the fluid flow path and configured to emit air toward the portion 1052 of the second towel 1044 located adjacent an outer surface 1062 of the rear lateral sidewall 1020. An internal vent 1080, 1082, an external vent 1090, 1092, or combinations thereof may be located at any place along the vertical dimension of the lateral sidewall 1014. At least one top vent 1100 is located in the top 30 of the lateral sidewall 1014 and is in fluid communication with the fluid flow path and configured to emit air toward the at least one towel 1040. For example, at least one top vent can be located in the top 1030 of the front lateral sidewall 1018, the top 1030 of the rear lateral sidewall 1020, or a combination thereof to emit air toward the first towel 1042, the second towel 1044, or both. A base vent 1102 is located in the base 1012 and is in fluid communication with the fluid flow path and configured to emit air into the space 1016. The at least one front internal vent 1082, the at least one rear internal vent 1084, the at least one front external vent 1090, the at least one rear external vent 1092, the at least one top vent 1100, the at least one base vent 1102, or any combination thereof can be configured to dry the first towel 1042, the second towel 1044, or both. The at least one front internal vent 1082, the at least one rear internal vent 1084, the at least one front external vent 1090, the at least one rear external vent 1092, the at least one top vent 1100, the at least one base vent 1102, or any combination thereof can also be configured to heat the first towel 1042, the second towel 1044, or both. The at least one front internal vent 1082, the at least one rear internal vent 1084, the at least one front external vent 1090, the at least one rear external vent 1092, the at least one top vent 1100, the at least one base vent 1102, or any combination thereof can also be configured to cool the first towel 1042, the second towel 1044, or both.

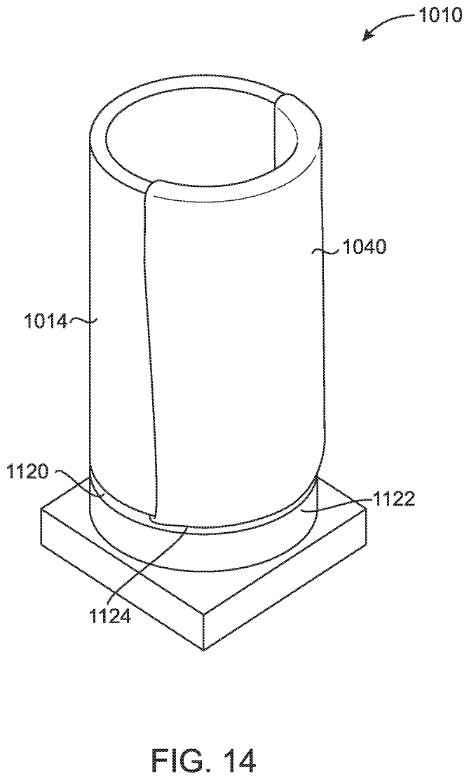

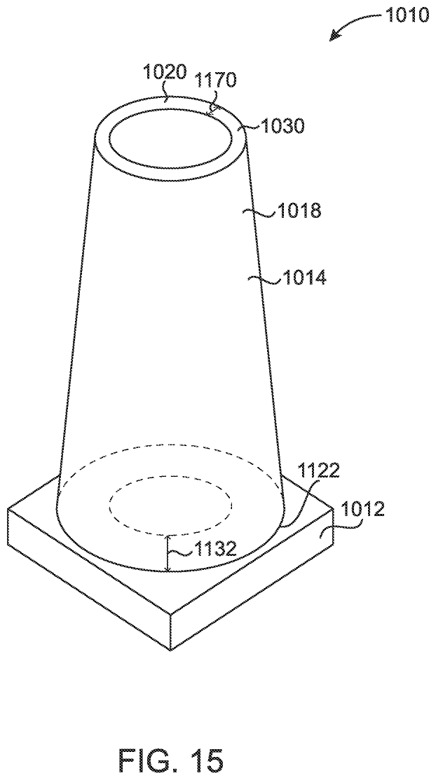

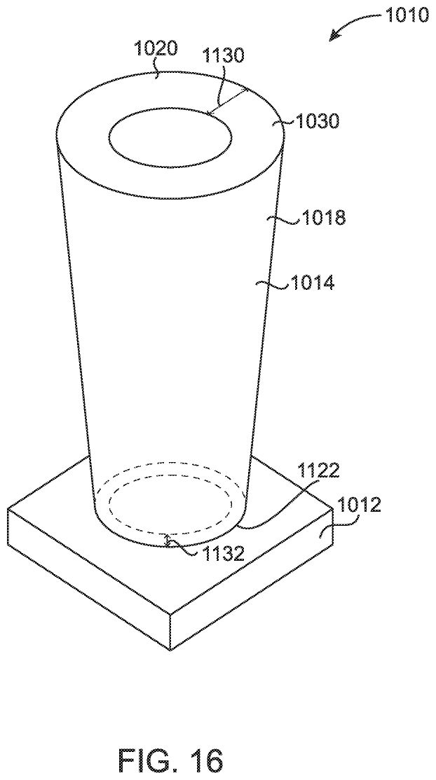

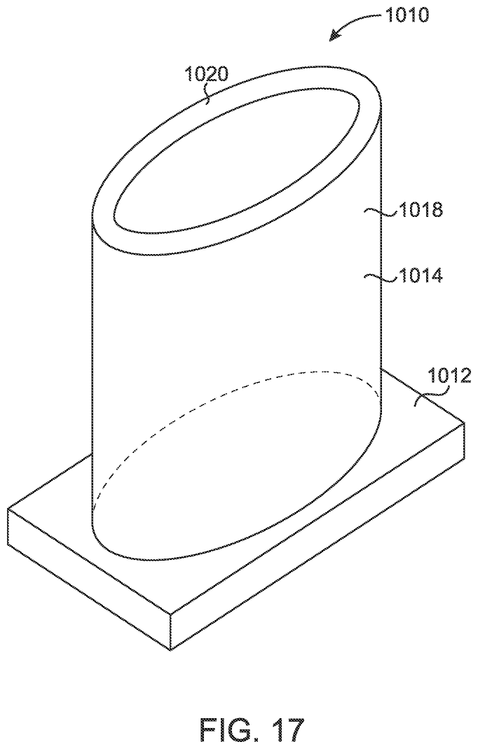

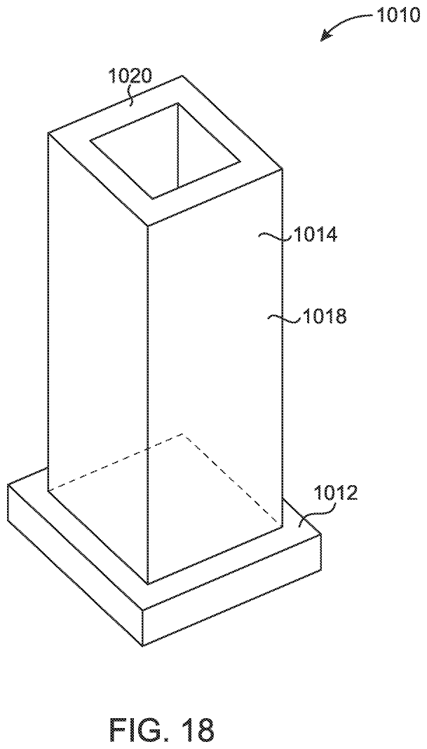

Referring to FIGS. 14-18, various embodiments of the towel rack 1010 are illustrated. FIG. 14 illustrates the towel rack 1010 having a groove or notch 1120 extending around a bottom 1122 of the lateral sidewall 1014. The groove 1120 is configured to receive an end 1124 of the at least one towel 1040. That is, the end 1124 of the at least one towel 1040 is tucked into the groove 1120 so that the towel 1040 is held tightly against the respective outer surface 1060 of the front lateral sidewall 1018 or the outer surface 1062 of the rear lateral sidewall 1020. FIG. 15 illustrates the towel rack 1010, wherein a thickness 1130 of the top 1030 of the front lateral sidewall 1018 and the rear lateral sidewall 1020 is less than a thickness 1132 of the bottom 1122 of the front lateral sidewall 1018 and the rear lateral sidewall 1020. That is, the thickness of the lateral sidewall 1014 decreases from the base 1012 to the top 1030. FIG. 16 illustrates the towel rack 1010, wherein the thickness 1130 of the top 1030 of the front lateral sidewall 1018 and the rear lateral sidewall 1020 is greater than the thickness 1132 of the bottom 1122 of the front lateral sidewall 1018 and the rear lateral sidewall 1020. That is, the thickness of the lateral sidewall 1014 increases from the base 1012 to the top 1030. FIG. 17 illustrates an embodiment of the towel rack 1010, wherein the first lateral sidewall 1018 and the second lateral sidewall 1020 form an elongated oval extending from the base 1012. FIG. 18 illustrates an embodiment of the towel rack 1010, wherein the first lateral sidewall 1018 and the second lateral sidewall 1020 form an elongated rectangle extending from the base 1012.

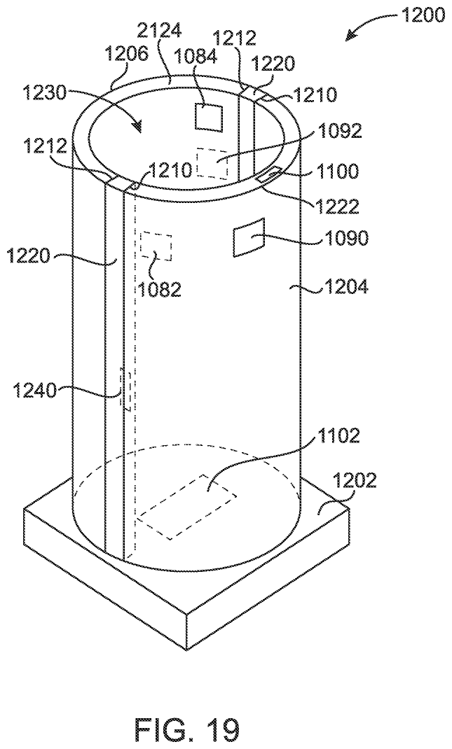

Referring now to FIG. 19, a towel rack 1200 includes a base 1202 and a front lateral sidewall 1204 and a rear lateral sidewall 1206 extending from the base 1202. The front lateral sidewall 1204 and the rear lateral sidewall 1206 are not integrally formed. Ends 1210 of the front lateral sidewall 1204 and ends 1212 of the rear lateral sidewall 1206 are coupled to a pair of lateral supports 1220 so that an apex 1222 of the front lateral sidewall 1204 and an apex 1224 of the rear lateral sidewall 1206 are positioned opposite one another and the front lateral sidewall 1204 and the rear lateral sidewall 1206 define a space 1230. The towel rack 1200 can include any of the vents described with respect to the towel rack 1010, i.e. at least one front internal vent 1082, the at least one rear internal vent 1084, the at least one front external vent 1090, the at least one rear external vent 1092, the at least one top vent 1100, the at least one base vent 1102, or any combination thereof. The towel rack 1200 can also include lateral support vents 1240 located in at least one of the lateral supports 1220. The lateral support vents 1240 can be internal vents, external vents, or both. The towel rack 1200 can also include any of the configurations described in FIGS. 14-18.

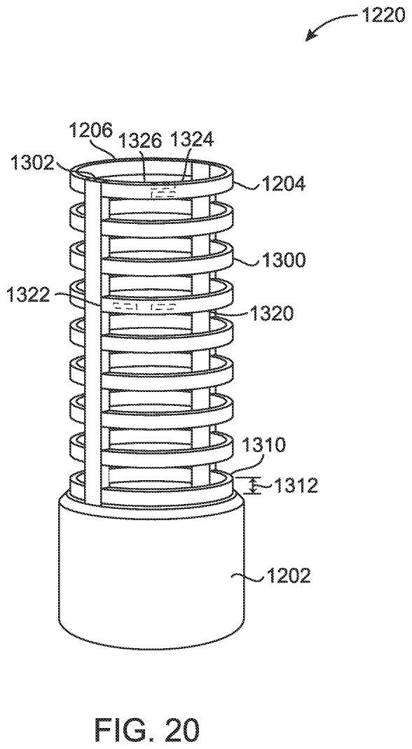

FIG. 20 illustrates an embodiment of the towel rack 1200, wherein each of the front lateral sidewall 1204 and the rear lateral sidewall 1206 includes a plurality of sidewall segments 1300. In some embodiments, only the front lateral sidewall 1204 includes a plurality of sidewall segments 1300. In another embodiment, only the rear lateral sidewall 1206 includes a plurality of sidewall segments 1300. In the illustrated embodiment, each of the sidewall segments 1300 is equally spaced apart between the top 1302 of the respective front lateral sidewall 1204 and rear lateral sidewall 1206 and the base 1202. It will be appreciated that in some embodiments, the sidewall segments 1300 can have variable spacing. Also, in the illustrated embodiment, each of the sidewall segments 1300 has the same thickness 1310 and height 1312.

At least one of the sidewall segments 1300 includes an internal vent 1320 that is in fluid communication with the fluid flow path and configured to emit air into the space 1230. In some embodiments, each of the sidewall segments 1300 includes an internal vent 1320. At least one of the sidewall segments 1300 includes an external vent 1322 located in an outer surface 1324 of the sidewall segment 1300 that is in fluid communication with the fluid flow path and configured to emit air outward. In some embodiment, each of the sidewall segments 1300 includes an external vent 1322. In some embodiments, at least one of the sidewall segments 1300 includes a top vent 1324 and/or a bottom vent 1326. In the embodiment illustrated in FIG. 20, fluid flow path extends through the lateral supports 1220 and each of the plurality of sidewall segments 1300 that includes an internal vent 1320, an external vent 1322, a top vent 1324, and/or bottom vent 1326. The embodiment illustrated in FIG. 20 can also include lateral support vents 1240.

At least two of the sidewall segments 1300 can have a different thickness 1310. The thickness 1310 of the sidewall segments 1300 can decrease from the base 1202 to the top 1302. The thickness 1310 of the sidewall segments 1300 can increase from the base 1202 to the top 1302. At least two of the sidewall segments 1300 can have a different height 1312. The height 1312 of the sidewall segments 1300 can increase from the base 1202 to the top 1302. The height 1312 of the sidewall segments 1300 can decrease from the base 1202 to the top 1302.

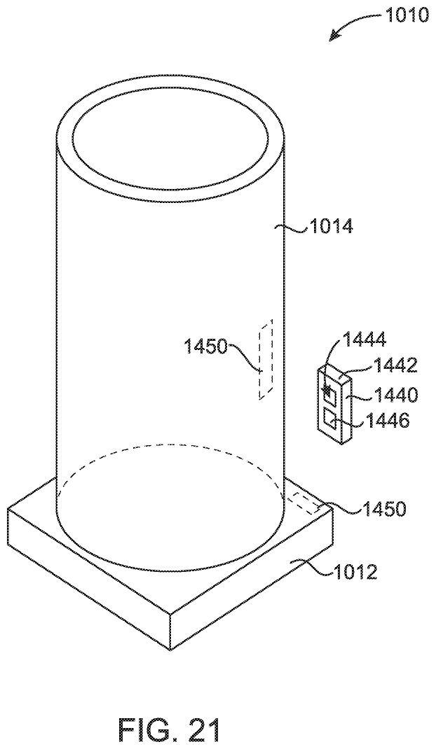

FIG. 21 illustrates an embodiment of the towel rack 1010 including an aromatherapy cartridge 1440. It should be noted that the aromatherapy cartridge 1440 can also be used with the towel rack 1200. The aromatherapy cartridge 1440 includes a housing 1442 that encloses a solid gel 1444 having aromatherapy particles. The gel 1444 is solid so that the aromatherapy cartridge 1440 can be positioned in any orientation. The housing 1442 includes vents 1446 that emit the aromatherapy particles when the gel 1444 is heated. The gel is activated when the air emitted from the towel rack 1010 reaches a predetermined temperature. In one embodiment, the predetermined temperature is approximately 225° F.

The aromatherapy cartridge 1440 can be clipped to the towel rack 1010 and located adjacent any of the vents described above. Alternatively, the aromatherapy cartridge 1440 is positioned in a slot 1450 formed in the towel rack 1010 and located in fluid communication with the fluid flow path. The slot 1450 can be arranged in any of the lateral supports or sidewalls 1014 described herein. In some embodiments, the slot 1450 is positioned in the base 1012. The air emitted through the fluid flow path heats the gel 1444 to the predetermined temperature so that the aromatherapy particles are distributed in to the space 1016.

In some embodiments, the heating element 1072 can be configured to produce heat and/or heated air at a temperature which kills pathogens, germs, bacteria, and/or viruses. For example, components of the towel racks 1010, 1200 can be heated to temperatures in the range of 135° F.-220° F. In an embodiment, the components can be heated to a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. Accordingly, any article, garment, or towel which contacts the components which have been heated to a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. can have its temperature raised to a temperature which is the same or substantially the same as the heated component via conduction and/or convection. Additionally and or alternatively, air which is emitted from the plurality of vents describe herein can be emitted at temperatures in the range of 135° F.-220° F. For example, air exiting any and/or all of the plurality of vents can exit any and/or all vents at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. Accordingly, any article, garment, or towel which contacts, or is in proximity to, any of the plurality of vents emitting air at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. can have its temperature raised to a temperature which is the same or substantially the same as the air exiting any or all of the plurality of vents via conduction and/or convection.

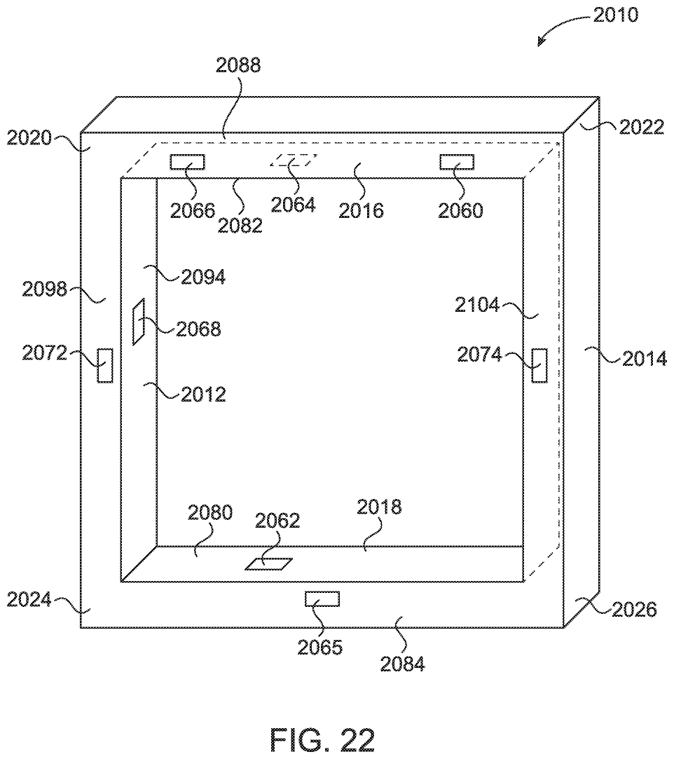

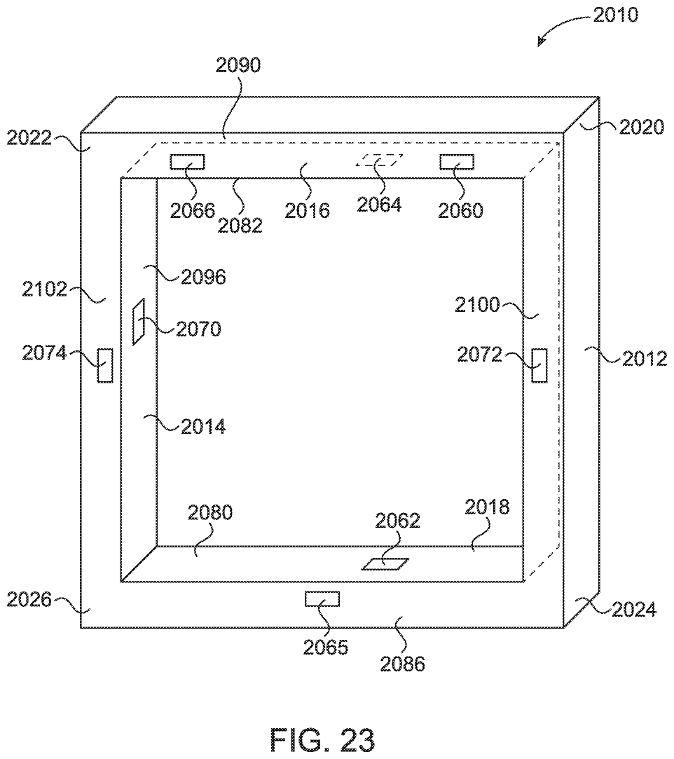

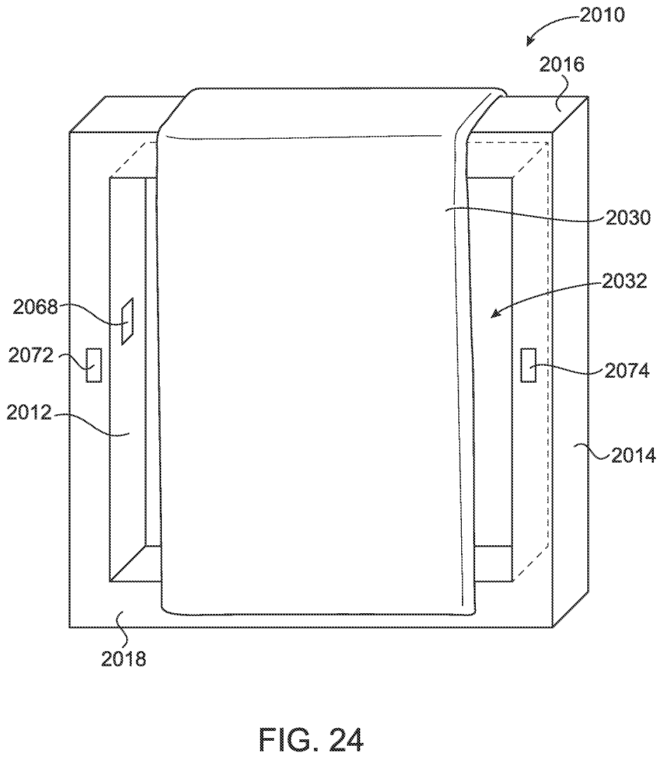

Referring to FIGS. 22 and 23 a towel rack 2010 for drying, heating, and/or cooling a towel includes a left lateral support 2012 and a right lateral support 2014. An upper cross structure 2016 and a lower cross structure 2018 extend between the left lateral support 2012 and the right lateral support 2014. In some embodiments, the upper cross structure 2016 is differently sized from the lower cross structure 2018. In the illustrated embodiment, the upper cross structure 2016 extends between a top 2020 of the left lateral support 2012 and a top 2022 of the right lateral support 2014, and the lower cross structure 2018 extends between a bottom 2024 of the left lateral support 2012 and a bottom 2026 of the right lateral support 2014 so that the left lateral support 2012, the right lateral support 2014, the upper cross structure 2016, and the lower cross structure 2018 form a box or rectangular configuration. In some embodiments, the upper cross structure 2016 can extend between any portion of the left lateral support 2012 and the right lateral support 2014, and/or the lower cross structure 2018 can extend between any portion of the left lateral support 2012 and the right lateral support 2014. The upper cross structure 2016, the lower cross structure 2018, the left lateral support 2012, and the right lateral support 2014 are configured to support a towel 2030, as shown in FIG. 24. The towel 2030 is configured to be supported so that upper cross structure 2016, the lower cross structure 2018, the left lateral support 2012, the right lateral support 2014, and the towel 2030 to form a space 2032. The space 2032 is configured to be at least partially sealed when the towel 2030 is supported by upper cross structure 2016, the lower cross structure 2018, the left lateral support 2012, and the right lateral support 2014.

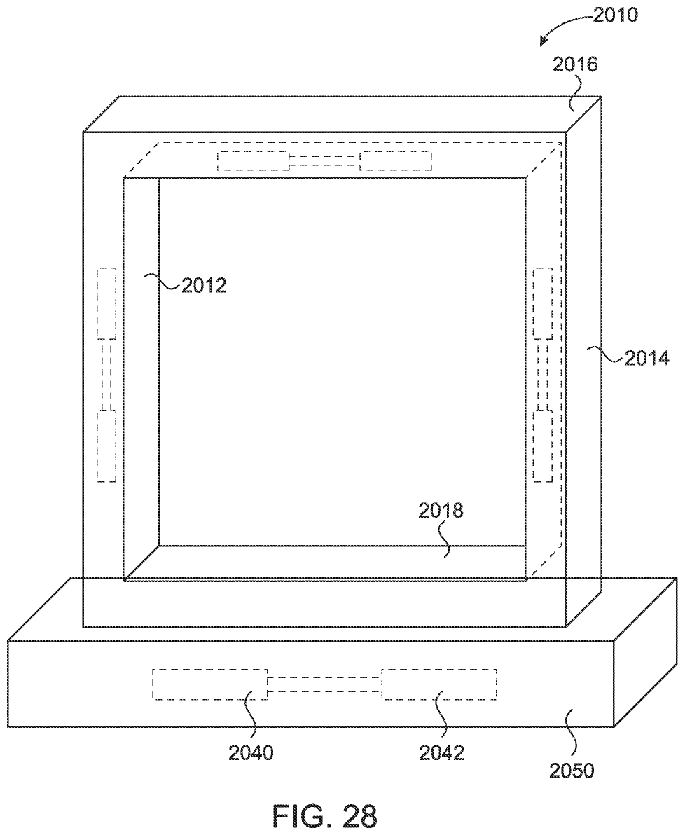

The towel rack 2010 can be secured to a wall. For example, at least one of the upper cross structure 2016, the lower cross structure 2018, the left lateral support 2012, and the right lateral support 2014 can be secured to the wall with a bracket. In another embodiment, shown in FIG. 28, the towel rack 2010 includes a base 2050. In the illustrated embodiment, the left lateral support 2012 and the right lateral support 2014 extend from the base 2050, and the lower cross structure 2018 extends along the base 2050. In some embodiments, the lower cross structure 2018 can extend through the base 2050.

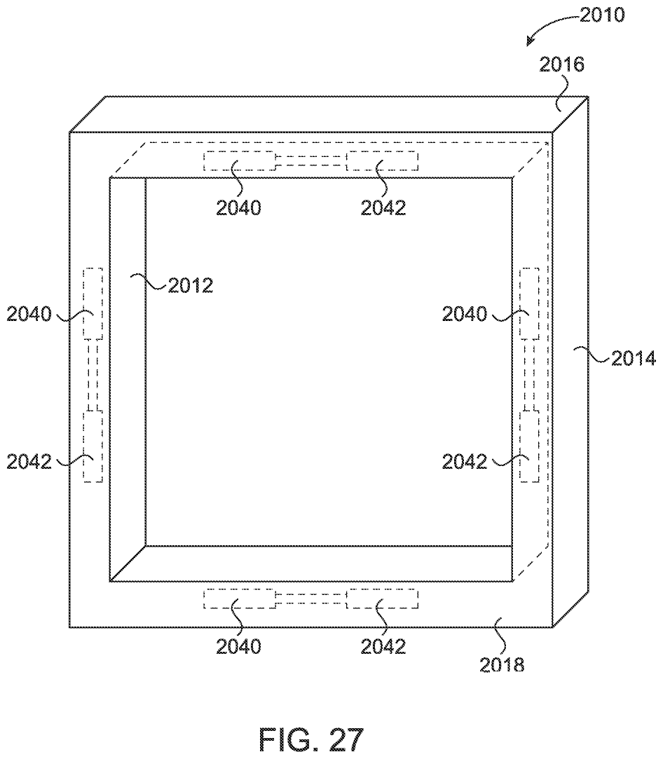

Referring back to FIGS. 22 and 23, at least one of the upper cross structure 2016, the lower cross structure 2018, the left lateral support 2012, and the right lateral support 2014 are configured to provide a fluid flow path which traverses at least one of the upper cross structure 2016, the lower cross structure 2018, the left lateral support 2012, and the right lateral support 2014. The towel rack 2010 includes a forced air unit 2040 that is in fluid communication with the fluid flow path and configured to force air through the fluid flow path. A heating element 2042 is in fluid communication with the forced air unit 2040 and configured to heat the air that is moved via the forced air unit 2040 through the fluid flow path. Referring to FIG. 27, the forced air unit 2040 and the heating element 2042 can be located in any one the upper cross structure 2016, the lower cross structure 2018, the left lateral support 2012, and the right lateral support 2014. In some embodiments, multiple heating elements can be located in the upper cross structure 2016, the lower cross structure 2018, the left lateral support 2012, and the right lateral support 2014, or combinations thereof. In the embodiment shown in FIG. 28, the forced air unit 2040 and the heating element 2042 are located in the base 2050.

Referring back to FIGS. 22 and 23, a vent 2060 is located in the at least one of the upper cross structure 2016, the lower cross structure 2018, the left lateral support 2012, and the right lateral support 2014. The vent is in fluid communication with the fluid flow path and is configured to emit air from the fluid flow path into the space 2032. That is, the space 2032 receives air which emitted from the vent 2060 from the forced air unit 2040. In the illustrated embodiment, the air emitted from the vent 2060 is heated by the heating element 2042 to dry and/or heat the towel 2030. In some embodiments, the air emitted from the vent 2060 is not heated by the heating element 2042 and the air cools the towel 2030. A vent 2060 can be located in two of the upper cross structure 2016, the lower cross structure 2018, the left lateral support 2012, and the right lateral support 2014. A vent 2060 can be located in three of the upper cross structure 2016, the lower cross structure 2018, the left lateral support 2012, and the right lateral support 2014. A vent 2060 can be located in each of the upper cross structure 2016, the lower cross structure 2018, the left lateral support 2012, and the right lateral support 2014.

In some embodiments, a lower vent 2062 is located in an upper surface 2080 of the lower cross structure 2018 and configured to emit the air upward into the space 2032. An upper vent 2064 can be located in a lower surface 2082 the upper cross structure 2016 and configured to emit the air downward into the space 2032. Another lower vent 2065 can be located in a front surface 2084 and/or a rear surface 2086 of the lower cross structure 2018 and configured to emit air toward a portion of the towel 2030. Another upper vent 2066 can be located in a front surface 2088, a rear surface 2090, and/or an upper surface 2092 of the lower cross structure 2018 and configured to emit air toward a portion of the towel 2030. A left lateral vent 2068 can be located in an inner surface 2094 of the left lateral support 2012 and configured to emit air into the space 2032. Likewise, a right lateral vent 2070 can be located in an inner surface 2096 of the right lateral support 2014 and configured to emit air into the space 2032. Another left lateral vent 2072 can be located in a front surface 98 and/or a rear surface 100 of the left lateral support 2012 and configured to emit air toward a portion of the towel 2030. Another right lateral vent 2074 can be located in a front surface 2102 and/or a rear surface 2104 of the right lateral support 2014 and configured to emit air toward a portion of the towel 2030. It will be appreciated that the towel rack 2010 can includes any combination of vents 2062, 2064, 2066, 2068, 2070, 2072, and/or 2074.

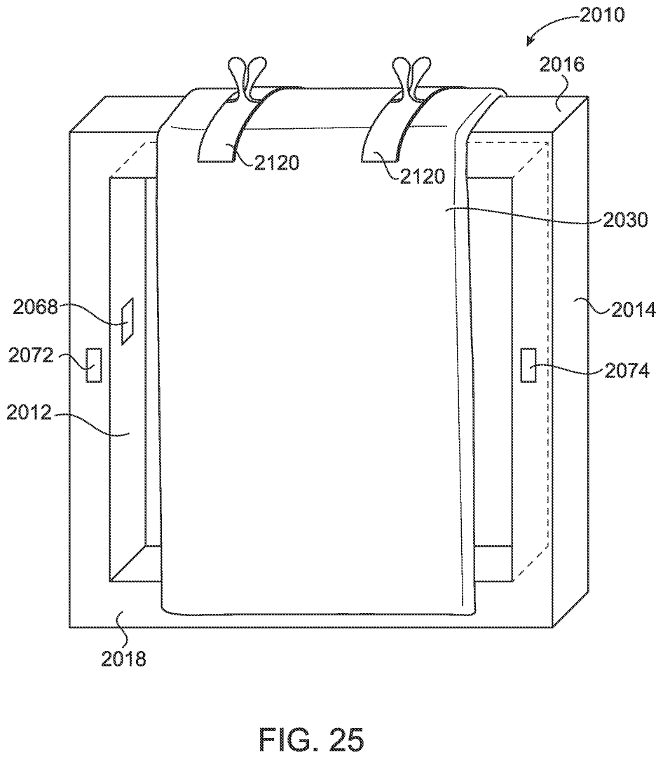

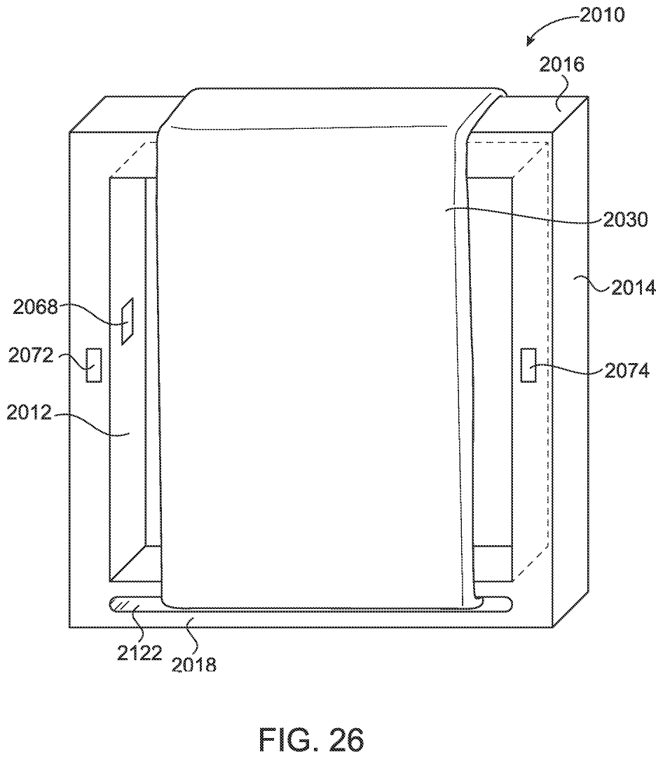

FIGS. 25 and 26 illustrate different embodiments for securing the towel 2030 to the towel rack 2010. In FIG. 25, the towel 2030 is secured to at least one of the upper cross structure 2016, the lower cross structure 2018, the left lateral support 2012, and the right lateral support 2014 with a of clip 2120 that is secured to the respective one of the upper cross structure 2016, the lower cross structure 2018, the left lateral support 2012, and the right lateral support 2014. It will be appreciated that as few as one clip 2120 can be used to secured the towel 2030. It will also be appreciated that a plurality of clips 2120 can be used to secure the towel 2030. In FIG. 26, the towel 2030 is secured into a groove 2122 form in at least one of the upper cross structure 2016, the lower cross structure 2018, the left lateral support 2012, the right lateral support 2014. It will be appreciated that only one of the upper cross structure 2016, the lower cross structure 2018, the left lateral support 2012, and the right lateral support 2014 can include a groove 2122. Alternatively, any combination of the upper cross structure 2016, the lower cross structure 2018, the left lateral support 2012, and the right lateral support 2014 can include a groove 2122. The space 2032 is configured to be at least partially sealed when the towel 2030 is secured to at least one of the upper cross structure 2016, the lower cross structure 2018, the left lateral support 2012, and the right lateral support 2014. The air emitted into the space 2032 is configured to be at least partially trapped by the towel when a towel is secured to at least one of the upper cross structure 2016, the lower cross structure 2018, the left lateral support 2012, and the right lateral support 2014.

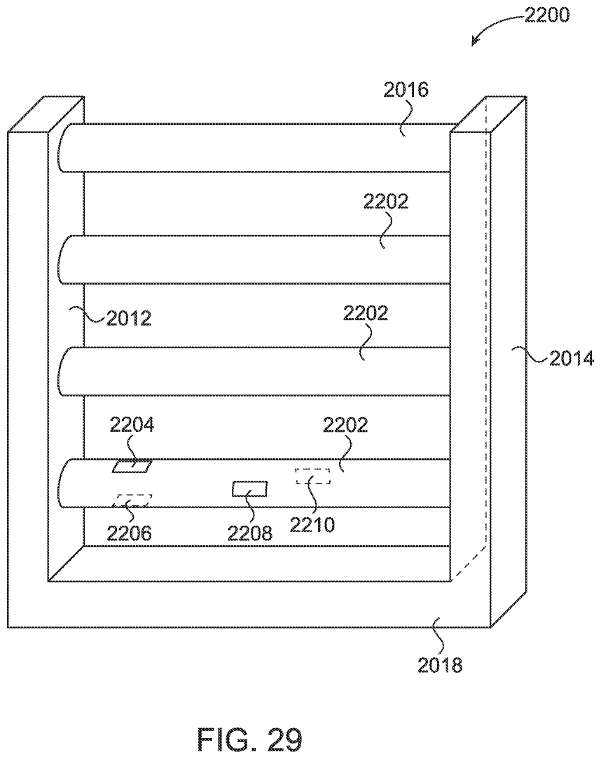

Referring now to FIG. 29, a towel rack 2200 includes all of the elements of the towel rack 2010, and additionally includes a plurality of intermediate cross structures 2202 extending between the left lateral support 2012 and the right lateral support 2014. The intermediate cross structures 2202 are located between the upper cross structure 2016 and the lower cross structure 2018. Each of the intermediate cross structures 2202 can include an upper surface vent 2204, a lower surface vent 2206, a front surface vent 2208, a rear surface vent 2210, or any combination thereof in fluid communication with the fluid flow path. The upper surface vent 2204 and the lower surface vent 2206 of each intermediate cross structure 2202 can be configured to emit air into the space 2032. The front surface vent 2208 and the rear surface vent 2210 can be configured to emit air toward a portion of the towel 2030.

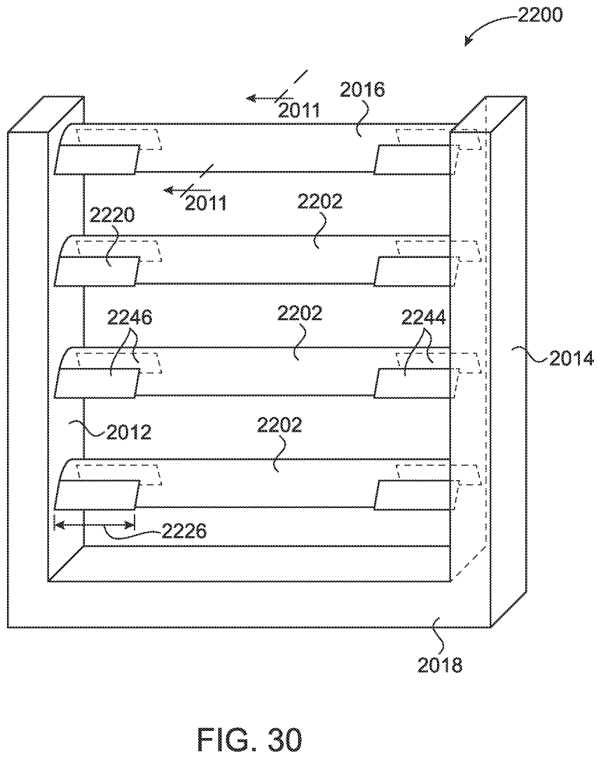

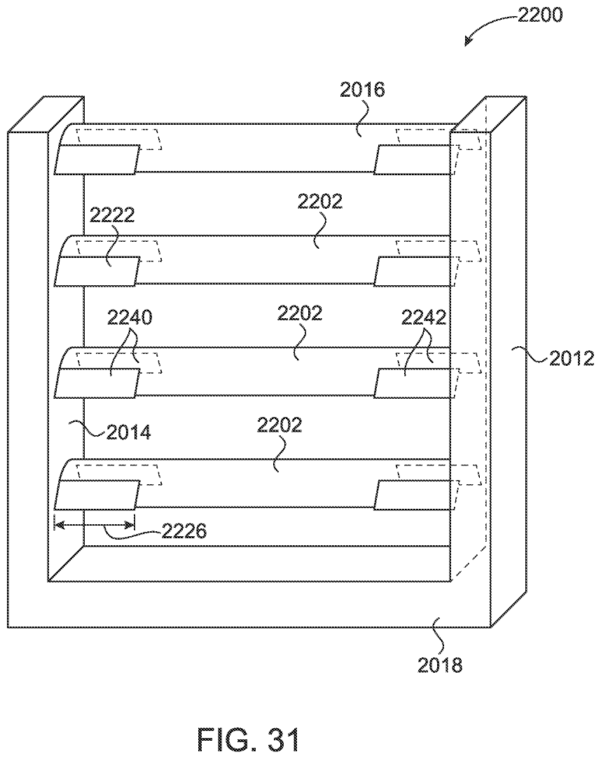

As illustrated in FIGS. 30 and 31, each of the upper cross structure 2016, the lower cross structure 2018, and the intermediate cross structures 2202 include a front panel 2220 and a back panel 2222 extending from the respective cross structure 2016, 18, 202. The front panel 2220 and/or the back panel 2222 can have an adjustable length 2226 along an axis 2230 of the respective cross structure 2016, 2018, 2202. In the illustrated embodiment, each front panel 2220 includes left front panel 2240 located adjacent the left lateral support 2012 and a right front panel 2242 located adjacent the right lateral support 2014. In the illustrated embodiment, each back panel 2222 includes left back panel 2244 located adjacent the left lateral support 2012 and a right back panel 2246 located adjacent the right lateral support 2014. In some embodiments, the front panel 2220 and/or the back panel 2222 extends an entire length 2250 of the respective cross structure 2016, 2018, 2202.

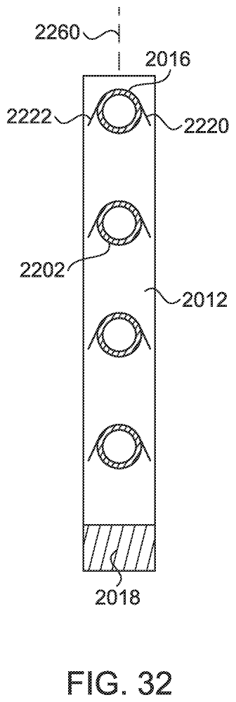

Referring to FIG. 32, wherein the front panels 2220 of each respective cross structure 2016, 2018, 2202 extend at an angle relative to the back panels 2222. In some embodiments, the front panels 2220 of only some of the respective cross structures 2016, 2018, 2202 extend at an angle relative to the back panels 2222. The front panel 2220 and the back panel 2220 of at least one respective cross structure 2016, 2018, 2202 can extend parallel to a vertical axis 2260 of the towel rack 2010. The front panel 2220 and the back panel 2220 of at least one respective cross structure 2016, 2018, 2202 can extend at an oblique angle relative to the vertical axis 2260 of the towel rack 2010. The front panel 2220 of at least one respective cross structure 2016, 2018, 2202 extends at an oblique angle relative to the respective back panel 2222.

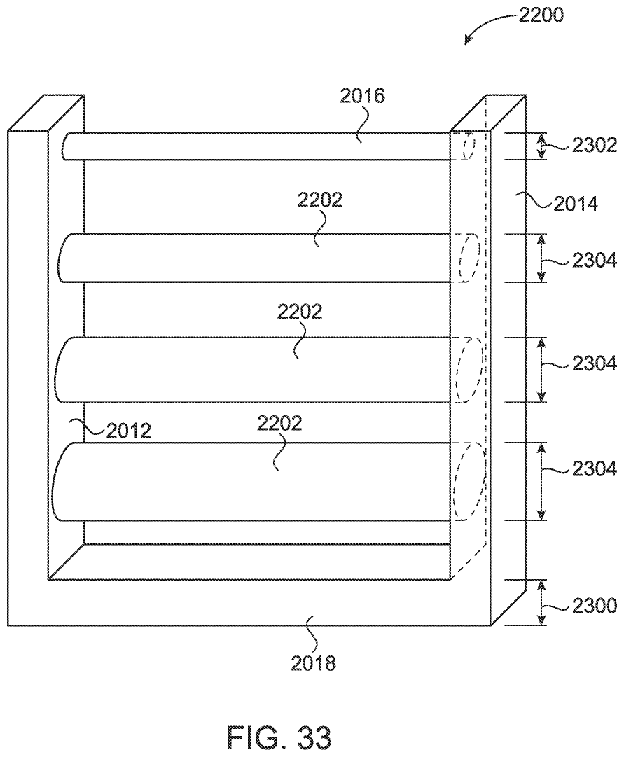

FIG. 33 illustrates the towel rack 2200, wherein the cross structures 2016, 2018, 2202 have different diameters. In the illustrated embodiment, the lower cross structure 2018 has a diameter 2300 that is greater than a diameter 2302 of the upper cross structure 2016. A diameter 2304 of the each of the plurality of intermediate cross structures 2202 is greater than the diameter 2302 of the upper cross structure 2016 and less than the diameter 2300 of the lower cross structure 2018. The diameter 2304 of each of the plurality of intermediate cross structures 2202 increases when moving from the upper cross structure 2016 to the lower cross structure 2018.

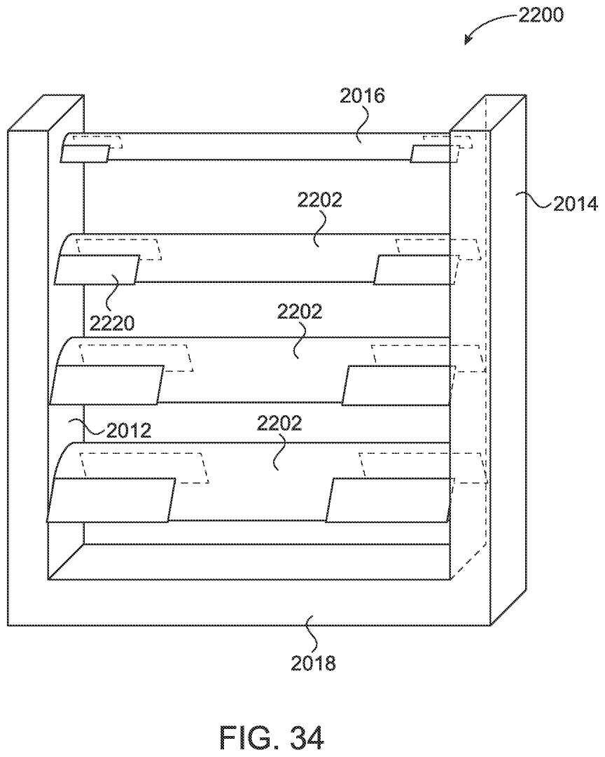

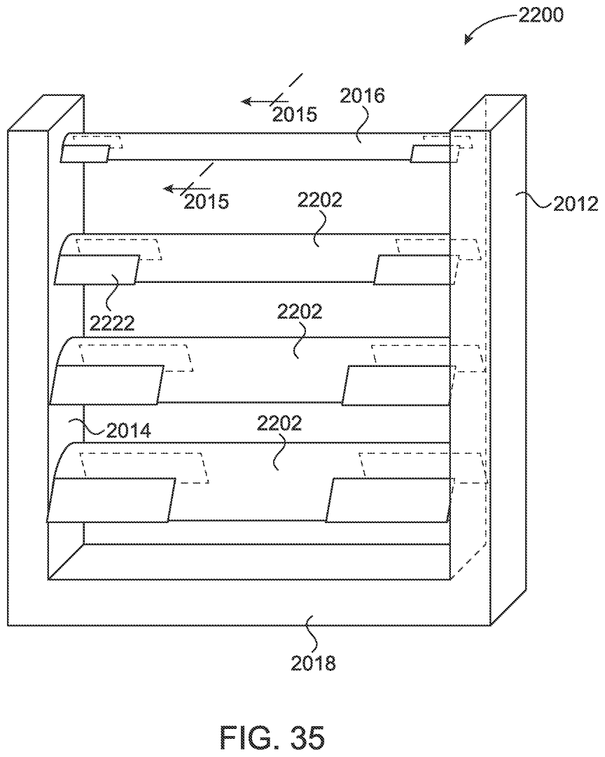

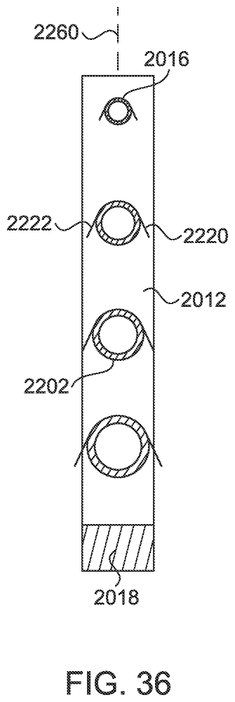

FIGS. 34-36 illustrate the towel rack shown in FIG. 33 having different size cross structures 2016, 2018, and 2202, wherein each of the upper cross structure 2016, the lower cross structure 2018, and the intermediate cross structures 2202 include the front panel 2220 and the back panel 2222 extending from the respective cross structure 2016, 2018, 2202, as described in FIGS. 32-34. It will be appreciated that any combination of the cross structures 2016, 2018, 2202, shown in FIGS. 36-38, can include the front panel 2220 and the back panel 2222.

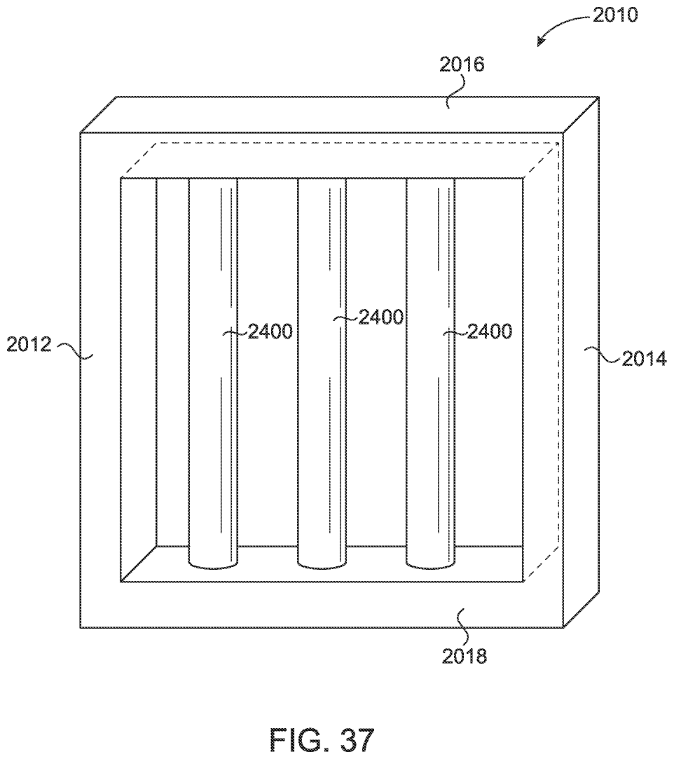

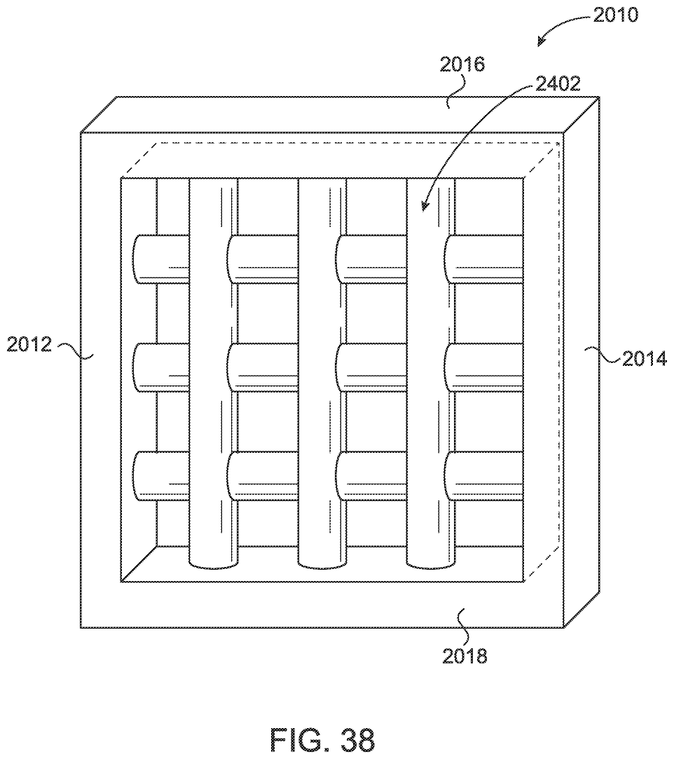

Referring to FIG. 37, the towel rack 2010 can include a plurality of intermediate lateral supports 2400 extending between the upper cross structure 2016 and the lower cross structure 2018. Each of the plurality of intermediate lateral supports 2400 is located between the left lateral support 2012 and the right lateral support 2014. It will be appreciated that the towel rack 2200 can also be configured with the plurality of intermediate lateral supports 2400 so that a lattice 2402 is formed, as shown in FIG. 38. The intermediate supports 2400 and/or lattice 2402 can be configured with any combination of vents, as described above, that are in fluid communication with the fluid flow path. Additionally, the plurality of intermediate supports 2400 and/or lattice 2402 can be utilized with any of the features described herein.

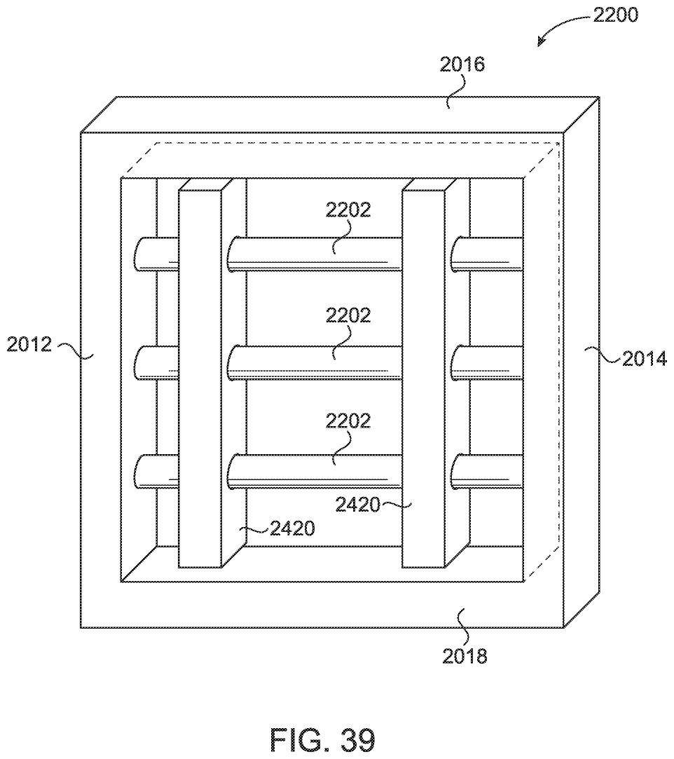

Referring now to FIG. 39, the towel rack 2200 can include at least one horizontally movable slat 2420 coupled to the upper cross structure 2016. The horizontally movable slat 2420 may be configured as a strip, a bar, a barrier or a heat capture structure of any material. In some embodiments, the horizontally movable slat 2420 can also be coupled to the lower cross structure 2018. The horizontally movable slat 2420 is configured to move horizontally along the towel rack 2200 to an edge of the towel 2030 so that the towel 2030 and the horizontally movable slat 2420 seal the space 2032. Accordingly, the towel rack 2200 can be adjusted to any size towel 2030 by moving the horizontally movable slat 2420. In some embodiments, the towel rack 2200 includes a pair of horizontally movable slats 2420, wherein each horizontally movable slat 2420 is positioned on one side of the towel 2030. The towel 2030 can be clipped to the horizontally movable slat 2420 using a clip 2120, as set forth in FIG. 25. In other embodiments, the horizontally movable slat 2420 can include a groove 2122 for securing the towel, as set forth in FIG. 26. The horizontally movable slats 2420 can be cut to slide on the cross structures 2016, 2018, 2202, or over the lattice 2402, or over any structure of the disclosed embodiments by being affixed in any manner. The horizontally movable slats 2420 can also include pins to fix the horizontally movable slats 2420 at a particular location. In some embodiments, the horizontally movable slats 2420 can increase heat capture in the towel rack 2010, 200.

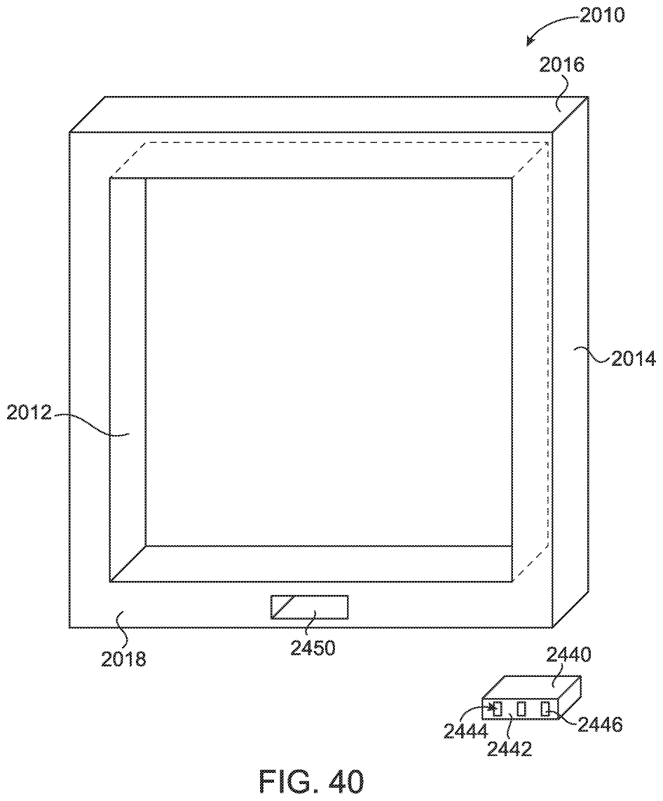

FIG. 40 illustrates an embodiment of the towel rack 2010 including an aromatherapy cartridge 2440. It should be noted that the aromatherapy cartridge 2440 can also be used with the towel rack 2200. The aromatherapy cartridge 2440 includes a housing 2442 that encloses a solid gel 2444 having aromatherapy particles. The gel 2444 is solid so that the aromatherapy cartridge 2440 can be positioned in any orientation. The housing 2442 includes vents 2446 that emit the aromatherapy particles when the gel 2444 is heated. The gel is activated when the air emitted from the towel rack 2010 reaches a predetermined temperature. In one embodiment, the predetermined temperature is approximately 225° F.

The aromatherapy cartridge 2440 can be clipped to the towel rack 2010 and located adjacent any of the vents described above. Alternatively, the aromatherapy cartridge 2440 is positioned in a slot 2450 formed in the towel rack 2010 and located in fluid communication with the fluid flow path. The slot 2450 can be arranged in any of the lateral supports or cross structures described herein. In some embodiments, the slot 2450 is positioned in the base 2050. The air emitted through the fluid flow path heats the gel 2444 to the predetermined temperature so that the aromatherapy particles are distributed in to the space 2032.

In some embodiments, the heating element 2042 of any of the embodiments described herein can be configured to produce heat and/or heated air at a temperature which kills pathogens, germs, bacteria, and/or viruses. For example, components of the towel racks 2010, 2200 can be heated to temperatures in the range of 135° F.-220° F. In an embodiment, the components can be heated to a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. Accordingly, any article, garment, or towel which contacts the components which have been heated to a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. can have its temperature raised to a temperature which is the same or substantially the same as the heated component via conduction and/or convection. Additionally and or alternatively, air which is emitted from the plurality of vents describe herein can be emitted at temperatures in the range of 135° F.-220° F. For example, air exiting any and/or all of the plurality of vents can exit any and/or all vents at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F. or 220° F. Accordingly, any article, garment, or towel which contacts, or is in proximity to, any of the plurality of vents emitting air at a temperature of 135° F., 140° F., 145° F., 150° F., 155° F., 160° F., 165° F., 170° F., 175° F., 180° F., 185° F., 190° F., 195° F., 200° F., 205° F., 210° F., 215° F., or 220° F. can have its temperature raised to a temperature which is the same or substantially the same as the air exiting any or all of the plurality of vents via conduction and/or convection.

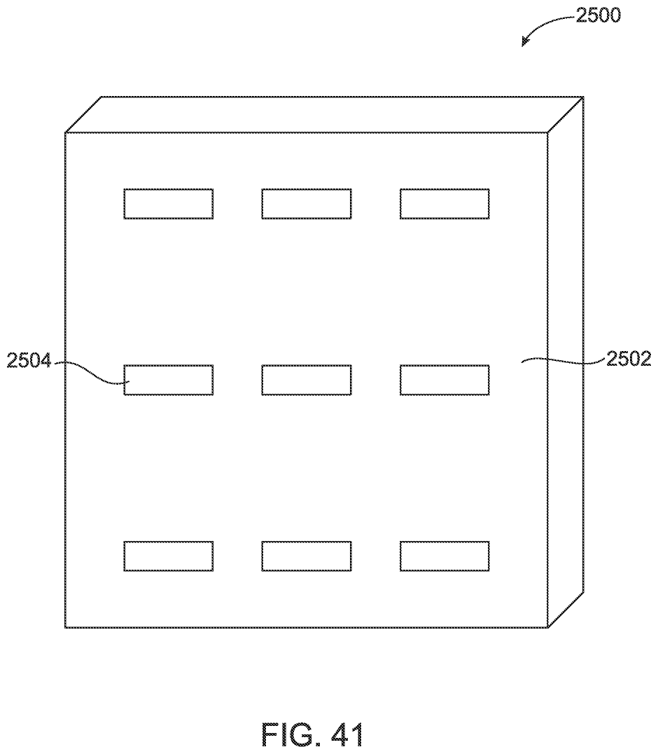

Referring now to FIG. 41, a towel rack 2500 includes a cross structure formed integrally with a pair of lateral supports to form a panel 2502. The towel rack 2500 include at least one vent 2504 configured to emit air, as described above. The towel rack 2500 can be positioned on a base, as described above. Additionally, the towel rack 2500 can include any of the features described in FIGS. 22-40, for example, varying degrees of thickness, a slot for an aromatherapy cartridge, the ability to kills pathogens, germs, bacteria, and/or viruses, horizontally moveable slats, a groove to retain the towel, clips, etc.

It will be appreciated that any of the features described above can be reasonably combined to form other embodiments of a towel rack and/or garment rack.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

The following clauses enumerated consecutively from 1 through 141 provide for various aspects of the present invention. In one embodiment, in a first paragraph (1), the present invention provides: a towel rack comprising:
a laterally extending cross structure;
a fluid flow path traversing the laterally extending cross structure;
a forced air unit positioned in the laterally extending cross structure;
a heating element that heats air which is moved via the forced air unit through the fluid flow path; and
a vent in fluid communication with the fluid flow path, wherein the laterally extending cross structure is configured to support a towel and cause the towel to receive air which emitted from the vent.
2. The towel rack of clause 1, wherein the laterally extending cross structure includes a plurality of cross bars forming a cross bar conduit.
3 The towel rack of clause 2, wherein the plurality of cross bars extends between a first lateral support and a second lateral support.
4. The towel rack of clause 2, wherein the plurality of cross bars includes:
a first plurality of cross bars forming a first cross bar conduit; and
a second plurality of cross bars forming a second cross bar conduit.
5. The towel rack of clause 2, wherein the vent includes:
a first vent traversing the first cross bar conduit; and
a second vent traversing the second cross bar conduit.
6. The towel rack of clause 2, wherein the second cross bar conduit is larger than the first cross bar conduit.
7. The towel rack of clause 1, wherein the laterally extending cross structure includes:
a first lateral sidewall extending from a base; and
a second lateral sidewall extending from the base.
8. The towel rack of clause 7, wherein ends of the first lateral sidewall and ends of the second lateral sidewall are configured to form a space between the first lateral sidewall and the second lateral sidewall.
9. The towel rack of clause 8, wherein the vent is configured to emit the air
into the space.
10. The towel rack of clause 1, further comprising:
a first lateral support;
a second lateral support,
wherein the laterally extending cross structure extends between the first lateral support and the second lateral support, wherein the fluid flow path traverses the laterally extending cross structure and at least one of the first lateral support and the second lateral support.
11. The towel rack of clause 10, wherein the vent is located in at least one of the laterally extending cross structure, the first lateral support, and the second lateral support and is in fluid communication with the fluid flow path.
12. The towel rack of clause 11, wherein the laterally extending cross structure, the first lateral support, and the second lateral support are configured to cause the towel to form a space which receives the air which emitted from the vent.
13. The towel rack of clause 10, wherein the laterally extending cross structure is formed integrally with the first lateral support and the second lateral support as a panel and the cross structure extends from a base.
14. The towel rack of clause 1, wherein the cross structure is formed in a lattice configuration.
15. The towel rack of clause 1, further comprising an aromatherapy cartridge in fluid communication with the fluid flow path so that the air emitted from the vent is mixed with aromatherapy particles from the aromatherapy cartridge.
16. The towel rack of clause 1, wherein the towel rack is configured to kill at least one of a pathogen, germ, bacterium, a virus, or combinations thereof.
17. The towel rack of clause 1, further comprising a horizontally moveable slat that slides along the laterally extending cross structure to facilitate increasing heat capture.
18. The towel rack of clause 1, wherein the towel rack is configured to heat an article, garment, or towel to a pre-selected temperature in a range of 135° F.-220° F. and maintain that pre-selected temperature for a pre-selected period of time in a range of 10 sec.-120 min.
19. The towel rack of clause 18, wherein the towel rack is further configured to cool the article, garment, or towel to a temperature which is less than the pre-selected temperature.
20. A towel rack comprising:
a first section, wherein the first section comprises a plurality of first section cross bars coupled thereto and wherein each of the plurality of first section cross bars comprise a first section cross bar conduit;
at least one first section vent, wherein the at least one first section vent traverses the first section cross bar conduit of at least one of the plurality of first section cross bars;
a second section, wherein the second section comprises a plurality of second section cross bars coupled thereto and wherein each of the plurality of second section cross bars comprise a second section cross bar conduit;
at least one second section vent, wherein the at least one second section vent traverses the second section cross bar conduit of at least one of the plurality of second section cross bars;
a plurality of lateral supports, wherein the first section and the second section are fluidly connected via the plurality of lateral supports;
at least one forced air unit in fluid communication with a channel within the plurality of lateral supports;
wherein the channel within the plurality of lateral supports is in fluid communication with the at least one first section vent, the at least one second section vent, or combinations thereof, and wherein the second section cross bar conduit is larger than the first section cross bar conduit.
21. The towel rack of clause 20, further comprising at least one heating element and a controller, wherein the at least one forced air unit comprises an air moving component, and wherein the controller is operatively coupled to the at least one heating element and the air moving component to control air temperature and flow through the at least one vent.
22. The towel rack of clause 21, wherein the at least one heating element is located in the at least one forced air unit.
23. The towel rack of clause 21, wherein the at least one heating element is located in at least one of the plurality of lateral supports.
24. The towel rack of clause 21, wherein the at least one heating element is located in the first section.
25. The towel rack of clause 21, wherein the at least one heating element is located in the second section.
26. The towel rack of clause 20, wherein the plurality of lateral supports comprise a first lateral support and a second lateral support, wherein the at least one forced air unit is coupled to the first lateral support.
27. The towel rack of clause 26, wherein at least one stopper is obstructively positioned within the conduit proximal to the second lateral support.
28. The towel rack of clause 26, comprising a plurality of stoppers obstructively positioned within at least one first section cross bar conduit, at least one second section cross bar conduit, or combinations thereof, and proximal to the second lateral support.
29. The towel rack of clause 20, further comprising an attachable aroma therapy element comprising a clip, a housing, at least one slot, and a scented compound, wherein:
the scented compound is positioned within the housing;
the at least one slot traverses the housing;
the attachable aroma therapy element is coupled to at least one of the plurality of first section cross bars or to at least one of the plurality of first section cross bars adjacent to at least one first section vent or at least one second section vent by way of the clip; and
the at least one slot is operatively aligned with the at least one first section vent or the at least one second section vent.
30. The towel rack of clause 20, wherein at least two of the plurality of first section cross bars comprise at least one first section vent, at least two of the plurality of second section cross bars comprise at least one second section vent, or combinations thereof.
31. A method for assembling a towel drying rack, the method comprising:
connecting one or more lateral supports to a plurality of cross bars, wherein a first portion of the plurality of cross bars constitutes a first section of the towel drying rack, and wherein a second portion of the plurality of cross bars constitutes a second section of the towel drying rack, and wherein a second section cross bar conduit is larger than a first section cross bar conduit;
fluidly connecting a channel within at least one of the lateral supports to at least one first section cross bar conduit and at least one second section cross bar conduit;
fluidly connecting at least one vent formed into at least one of the plurality of cross bars to at least one first section cross bar conduit or at least one second section cross bar conduit; and
fluidly connecting a forced air unit to at least one of the channel within at least one of the lateral supports, at least one first section cross bar conduit, and at least one second section cross bar conduit.
32. The method of clause 31, further comprising:
directing airflow, by the forced air unit, into the channel within the at least one of the lateral supports;
directing airflow from the channel into the at least one first section cross bar conduit, the at least one second section cross bar conduit, or combinations thereof; and
directing airflow from the at least one first section cross bar conduit, the at least one second section cross bar conduit, or combinations thereof out of the at least one vent formed into at least one of the plurality of cross bars toward a towel or garment.
33. The method of clause 31, further comprising fluidly connecting one or more heating elements to one or more of the forced air unit, each conduit of the plurality of cross bars, and the channel.
34. The method of clause 33, further comprising heating airflow generated by the forced air unit before the airflow exits the at least one vent formed into at least one of the plurality of cross bars.
35. The method of clause 31, further comprising connecting a controller to one or more of the elements of the towel drying rack; and manually or remotely controlling the operation of the towel drying rack via the controller.
36. The method of clause 31, further comprising attaching an aroma therapy element over at least one vent formed into the at least one of the plurality of cross bars.
37. A garment drying rack comprising:
at least one lateral support comprising a channel within an interior of the lateral support;
at least one forced air unit in fluid communication with the channel and configured to generate airflow into the channel;
a plurality of cross bars, wherein each of the plurality of cross bars comprise a conduit positioned within an interior of each of the plurality of cross bars, wherein the conduit of each of the plurality of cross bars is in fluid communication with the channel, wherein a first portion of the plurality of cross bars constitutes a first section of the garment drying rack, and wherein a second portion of the plurality of cross bars constitutes a second section of the garment drying rack, and wherein a second section cross bar conduit is larger than a first section cross bar conduit; and
a plurality of vents, wherein at least a first vent of the plurality of vents is in fluid communication with a first conduit of one of the plurality of cross bars and wherein at least a second vent of the plurality of vents is in fluid communication with a second conduit of one of the plurality of cross bars.
38. The garment drying rack of clause 37, further comprising one or more heating elements in fluid communication with one or more of the forced air unit, the conduit positioned within the interior of each of the plurality of cross bars, and the channel, wherein the one or more heating elements are configured to heat the airflow before it exits the plurality of vents.
39. The garment drying rack of clause 37, further comprising at least one aroma therapy element positioned over at least one of the plurality of vents configured to provide a scent that is spread via the airflow exiting the at least one of the plurality of vents.
40. A method of heating an article, garment, or towel to a pre-selected temperature in a range of 135° F.-220° F. and maintaining that pre-selected temperature for a pre-selected period of time in a range of 10 sec.-120 min.
41. The method of clause 40, further comprising the article, garment, or towel in contact with the towel rack as disclosed in any one of clauses 20 through 30.
42. The method of clause 40, further comprising the article, garment, or towel in contact with the garment drying rack as disclosed in any one of clauses 37 through 39.
43. The method of clause 40, clause 41, or clause 42, further comprising cooling the article, garment, or towel to a temperature which is less than the pre-selected temperature.
44. The towel rack of any of clauses 20 through 30, wherein the towel rack is configured to heat an article, garment, or towel to a pre-selected temperature in a range of 135° F.-220° F. and maintain that pre-selected temperature for a pre-selected period of time in a range of 10 sec.-120 min.
45. The towel rack of clause 44, wherein the towel rack is further configured to cool the article, garment, or towel to a temperature which is less than the pre-selected temperature.
46. The garment drying rack of any of clauses 37 through 39, wherein the garment drying rack is configured to heat an article, garment, or towel to a pre-selected temperature in a range of 135° F.-220° F. and maintain that pre-selected temperature for a pre-selected period of time in a range of 10 sec.-120 min.
47. The garment drying rack of clause 46, wherein the garment drying rack is further configured to cool the article, garment, or towel to a temperature which is less than the pre-selected temperature.
48. The method of clause 40, wherein the heating is sufficient to kill a pathogen, germ, bacterium, a virus, or combinations thereof.
49. The method of clause 41, wherein the heating is sufficient to kill a pathogen, germ, bacterium, a virus, or combinations thereof.
50. The method of clause 42, wherein the heating is sufficient to kill a pathogen, germ, bacterium, a virus, or combinations thereof.
51. The method of clause 43, wherein the heating is sufficient to kill a pathogen, germ, bacterium, a virus, or combinations thereof.
52. The towel rack of clause 44, wherein the towel rack is configured to kill a pathogen, germ, bacterium, a virus, or combinations thereof.
53. The towel rack of clause 45, wherein the towel rack is configured to kill a pathogen, germ, bacterium, a virus, or combinations thereof.
54. The garment drying rack of clause 46, wherein the garment drying rack is configured to kill a pathogen, germ, bacterium, a virus, or combinations thereof.
55. The garment drying rack of clause 47, wherein the garment drying rack is configured to kill a pathogen, germ, bacterium, a virus, or combinations thereof.
56. A towel rack comprising:
a base;
a first lateral sidewall extending from the base;
a second lateral sidewall extending from the base, wherein ends of the first lateral sidewall and ends of the second lateral sidewall are configured to form a space between the first lateral sidewall and the second lateral sidewall, wherein at least one of the first lateral sidewall and the second lateral sidewall are configured to provide a fluid flow path which traverses the respective first lateral sidewall and second lateral sidewall;
a forced air unit;
a heating element to heat air which is moved via the forced air unit through the fluid flow path;
an internal vent located in the at least one of the first lateral sidewall and the second lateral sidewall and in fluid communication with the fluid flow path and configured to emit the air into the space, wherein the first lateral sidewall, the second lateral sidewall, or a combination thereof, is configured to support at least one towel.
57. The towel rack of clause 56, wherein the first lateral sidewall is configured to support a first towel, and the second lateral sidewall is configured to support a second towel.
58. The towel rack of clause 56, wherein the ends of the first lateral sidewall are coupled to the ends of the second lateral sidewall.
59. The towel rack of clause 56, wherein the forced air unit is located in the base.
60. The towel rack of clause 56, wherein the at least one towel is dried by the air emitted into the space.
61. The towel rack of clause 56, wherein the at least one towel is heated by the air emitted into the space.
62. The towel rack of clause 56, wherein the at least one towel is cooled by the air emitted into the space.
63. The towel rack of clause 56, further comprising an external vent located in an outer surface of the first lateral sidewall, wherein the internal vent is configured to emit air toward a portion of the at least one towel located in the space, and the external vent is configured to emit air toward a portion of the at least one towel that is located adjacent the outer surface of the first lateral sidewall.
64. The towel rack of clause 63, wherein the at least one towel is dried by the air emitted by the external vent.
65. The towel rack of clause 63, wherein the at least one towel is heated by the air emitted by the external vent.
66. The towel rack of clause 63, wherein the at least one towel is cooled by the air emitted by the external vent.
67. The towel rack of clause 56, further comprising an external vent located in an outer surface of the second lateral sidewall, wherein the internal vent is configured to emit air toward a portion of the at least one towel located in the space, and the external vent is configured to emit air toward a portion of the at least one towel that is located adjacent the outer surface of the second lateral sidewall.
68. The towel rack of clause 67, wherein the at least one towel is dried by the air emitted by the external vent.
69. The towel rack of clause 67, wherein the at least one towel is heated by the air emitted by the external vent.
70. The towel rack of clause 67, wherein the at least one towel is cooled by the air emitted by the external vent.
71. The towel rack of clause 56, further comprising:
a first external vent located in an outer surface of the first lateral sidewall; and
a second external vent located in an outer surface of the second lateral sidewall, wherein the internal vent is configured to emit air toward portions of a first towel and a second towel located in the space,
wherein the first external vent is configured to emit air toward a portion of the first towel that is located adjacent the outer surface of the first lateral sidewall, and
wherein the second external vent is configured to emit air toward a portion of the second towel that is located adjacent the outer surface of the second lateral sidewall.
72. The towel rack of clause 71, wherein:
the first towel and the second towel are dried by the air emitted into the space,
the first towel is dried by the air emitted by the first external vent, and
the second towel is dried by the air emitted by the second external vent.
73. The towel rack of clause 71, wherein:
the first towel and the second towel are heated by the air emitted into the space,
the first towel is heated by the air emitted by the first external vent, and
the second towel is heated by the air emitted by the second external vent.
74. The towel rack of clause 71, wherein:
the first towel and the second towel are cooled by the air emitted into the space,
the first towel is cooled by the air emitted by the first external vent, and
the second towel is cooled by the air emitted by the second external vent.
75. The towel rack of clause 56, further comprising a base vent located in the base and configured to emit air upward into the space.
76. The towel rack of clause 56, wherein the first lateral sidewall and the second lateral sidewall are not integrally formed.
77. The towel rack of clause 76, further comprising:
a first lateral support, wherein a first end of the first lateral sidewall is coupled to a first end of the second lateral sidewall by the first lateral support; and
a second lateral support, wherein a second end of the first lateral sidewall is coupled to a second end of the second lateral sidewall by the second lateral support.
78. The towel rack of clause 56, wherein the first lateral sidewall and the second lateral sidewall form a cylinder extending from the base.
79. The towel rack of clause 56, wherein the first lateral sidewall and the second lateral sidewall form an elongated oval extending from the base.
80. The towel rack of clause 56, wherein the first lateral sidewall and the second lateral sidewall form an elongated rectangle extending from the base.
81. The towel rack of clause 56, wherein at least one of the first lateral sidewall and the second lateral sidewall comprises a solid wall extending between a top and the base.
82. The towel rack of clause 56, wherein at least one of the first lateral sidewall and the second lateral sidewall comprises sidewall segments that are spaced apart between a top and the base.
83. The towel rack of clause 82, wherein both of the first lateral sidewall and the second lateral sidewall comprise sidewall segments that are spaced apart between a top and the base.
84. The towel rack of clause 82, wherein each of the sidewall segments is equally spaced apart between the top and the base.
85. The towel rack of clause 82, wherein each of the sidewall segments has the same thickness.
86. The towel rack of clause 82, wherein at least two of the sidewall segments have a different thickness.
87. The towel rack of clause 86, wherein a thickness of the sidewall segments increases from the base to the top.
88. The towel rack of clause 86, wherein a thickness of the sidewall segments decreases from the base to the top.
89. The towel rack of clause 82, wherein each of the sidewall segments has the same height.
90. The towel rack of clause 82, wherein at least two of the sidewall segments have a different height.
91. The towel rack of clause 90, wherein a height of the sidewall segments increases from the base to the top.
92. The towel rack of clause 90, wherein a height of the sidewall segments decreases from the base to the top.
93. The towel rack of clause 82, wherein at least one of the sidewall segments includes an internal vent.
94. The towel rack of clause 82, wherein each of the sidewall segments includes an internal vent.
95. The towel rack of clause 82, wherein at least one of the sidewall segments includes an external vent located in an outer surface of the sidewall segment.
96. The towel rack of clause 82, wherein each of the sidewall segments includes an external vent located in an outer surface of the sidewall segment.
97. The towel rack of clause 56, wherein at least one of the first lateral sidewall and the second lateral sidewall includes a top vent located in a top surface of the respective first lateral sidewall and second lateral sidewall.
98. The towel rack of clause 56, wherein a thickness of the first lateral sidewall and the second lateral sidewall increases from the base to the top.
99. The towel rack of clause 56, wherein a thickness of the first lateral sidewall and the second lateral sidewall decreases from the base to the top.
100. The towel rack of clause 56, further comprising an aromatherapy cartridge in fluid communication with the fluid flow path so that the air emitted from the vent is mixed with aromatherapy particles from the aromatherapy cartridge.
101. The towel rack of clause 56, wherein the towel rack is configured to kill a pathogen, germ, bacterium, a virus, or combinations thereof.
102. A towel rack comprising:
a first lateral support;
a second lateral support;
a cross structure extending between the first lateral support and the second lateral support, wherein at least one of the cross structure, the first lateral support, and the second lateral support is configured to provide a fluid flow path which traverses at least one of the cross structure, the first lateral support, and the second lateral support;
a forced air unit;
a heating element that heats air which is moved via the forced air unit through the fluid flow path; and
a vent is located in at least one of the cross structure, the first lateral support, and the second lateral support and is in fluid communication with the fluid flow path, wherein the cross structure, the first lateral support, and the second lateral support are further configured to support a towel and cause the towel to form a space which receives air which emitted from the vent.
103. The towel rack of clause 102, wherein the vent is configured to emit the air toward a portion of the towel.
104. The towel rack of clause 102, wherein the cross structure includes a lower cross structure and an upper cross structure.
105. The towel rack of clause 104, wherein the vent is located in the lower cross structure and configured to emit the air in any direction.
106. The towel rack of clause 104, wherein the vent is located in the upper cross structure and configured to emit the air in any direction.
107. The towel rack of clause 104 wherein a vent is located in two of the lower cross structure, the upper cross structure, the first lateral support, and the second lateral support.
108. The towel rack of clause 104, wherein a vent is located in three of the lower cross structure, the upper cross structure, the first lateral support, and the second lateral support.
109. The towel rack of clause 104, wherein a vent is located in each of the lower cross structure, the upper cross structure, the first lateral support, and the second lateral support.
110. The towel rack of clause 104, wherein:
a lower cross structure vent is located in the lower cross structure and configured to emit air in any direction,
an upper cross structure vent is located in the upper cross structure and configured to emit air in any direction,
a first lateral support vent is located in the first lateral support and configured to emit air in any direction, and
a second lateral support vent is located in the second lateral support and configured to emit air in any direction.
111. The towel rack of clause 104, wherein at least one of the lower cross structure and the upper cross structure comprises:
a first vent configured to emit air in any direction, and
a second vent configured to emit air toward the towel.
112. The towel rack of clause 111, wherein the second vent is located on at least one of a front and back of the at least one of the lower cross structure and the upper cross structure.
113. The towel rack of clause 111, wherein the first vent is located on at least one of a top and bottom of the at least one of the lower cross structure and the upper cross structure.
114. The towel rack of clause 104, wherein the lower cross structure is differently sized from the upper cross structure.
115. The towel rack of clause 104, further comprising a plurality of intermediate cross structures extending between the first lateral support and the second lateral support between the lower cross structure and the upper cross structure.
116. The towel rack of clause 115, wherein the lower cross structure has a diameter that is different than a diameter of the upper cross structure.
117. The towel rack of clause 116, wherein each of the plurality of intermediate cross structures has a different diameter, wherein the diameter of the each of the plurality of intermediate cross structures is different than the diameter of the lower cross structure and the diameter of the upper cross structure.
118. The towel rack of clause 117, wherein the diameter of each of the plurality of intermediate cross structures increases when moving from the lower cross structure to the upper cross structure.
119. The towel rack of clause 117, wherein the diameter of each of the plurality of intermediate cross structures decreases when moving from the lower cross structure to the upper cross structure.
120. The towel rack of clause 104, further comprising a plurality of intermediate lateral supports extending between the lower cross structure and the upper cross structure between the first lateral support and the second lateral support.
121. The towel rack of clause 102, wherein the cross structure is formed in a lattice configuration.
122. The towel rack of clause 102, further comprising a base, wherein the first lateral support and the second lateral support extend from the base.
123. The towel rack of clause 122, wherein the cross structure is formed integrally with the first lateral support and the second lateral support as a panel and the cross structure extends from the base.
124. The towel rack of clause 123, wherein the cross structure houses the forced air unit and the heating element.
125. The towel rack of clause 122, wherein the base houses the forced air unit and the heating element.
126. The towel rack of clause 102, wherein the forced air unit and the heating element are housed in one of the first lateral support and the second lateral support.
127. The towel rack of clause 102, wherein the space is configured to be at least partially sealed when a towel is supported by the cross structure, the first lateral support, and the second lateral support.
128. The towel rack of clause 127, wherein the air emitted into the space is configured to be at least partially trapped by the towel when a towel is supported by the cross structure, the first lateral support, and the second lateral support.
129. The towel rack of clause 102, wherein the cross structure further comprises a front panel and a back panel extending from the cross structure to support the towel.
130. The towel rack of clause 129, wherein the front panel extends at an angle relative to the back panel.
131. The towel rack of clause 129, wherein at least one of the front panel and the back panel extends parallel to a vertical axis.
132. The towel rack of clause 129, wherein at least one of the front panel and the back panel extends at an oblique angle to a vertical axis.
133. The towel rack of clause 129, wherein at least one of the front panel and the back panel has an adjustable length along an axis of the cross structure.
134. The towel rack of clause 129, wherein the front panel includes:
a first front panel located adjacent the first lateral support, and a second front panel located adjacent the second lateral support.
135. The towel rack of clause 129, wherein the back panel includes:
a first back panel located adjacent the first lateral support, and
a second back panel located adjacent the second lateral support.
136. The towel rack of clause 129, wherein at least one of the front panel and the back panel extends an entire length of the cross structure.
137. The towel rack of clause 129, further comprising a plurality of cross structures extending between the first lateral support and the second lateral support, wherein each of the plurality of cross structures includes a respective front panel and back panel.
138. The towel rack of clause 102, further comprising an aromatherapy cartridge in fluid communication with the fluid flow path so that the air emitted from the vent is mixed with aromatherapy particles from the aromatherapy cartridge.
139. The towel rack of clause 102, wherein the towel rack is configured to kill a pathogen, germ, bacterium, a virus, or combinations thereof.
140. The towel rack of clause 102, further comprising a horizontally moveable slat that slides along the cross structure to facilitate increasing heat capture.
141. The towel rack of clause 102, wherein the cross structure is formed integrally with the first lateral support and the second lateral support as a panel.

1-141. (canceled)

142. A towel rack comprising:
a laterally extending cross structure;
a fluid flow path traversing the laterally extending cross structure;
a forced air unit positioned in the laterally extending cross structure;
a heating element that heats air which is moved via the forced air unit through the fluid flow path; and
a vent in fluid communication with the fluid flow path, wherein the laterally extending cross structure is configured to support a towel and cause the towel to receive air which emitted from the vent.

143. The towel rack of claim 142, wherein the laterally extending cross structure includes a plurality of cross bars forming a cross bar conduit.

144. The towel rack of claim 143, wherein the plurality of cross bars extends between a first lateral support and a second lateral support.

145. The towel rack of claim 143, wherein the plurality of cross bars includes:
a first plurality of cross bars forming a first cross bar conduit; and
a second plurality of cross bars forming a second cross bar conduit.

146. The towel rack of claim 143, wherein the vent includes:
a first vent traversing the first cross bar conduit; and
a second vent traversing the second cross bar conduit.

147. The towel rack of claim 143, wherein the second cross bar conduit is larger than the first cross bar conduit.

148. The towel rack of claim 142, wherein the laterally extending cross structure includes:
a first lateral sidewall extending from a base; and
a second lateral sidewall extending from the base.

149. The towel rack of claim 148, wherein ends of the first lateral sidewall and ends of the second lateral sidewall are configured to form a space between the first lateral sidewall and the second lateral sidewall.

150. The towel rack of claim 142, further comprising:
a first lateral support;
a second lateral support, wherein the laterally extending cross structure extends between the first lateral support and the second lateral support, wherein the fluid flow path traverses the laterally extending cross structure and at least one of the first lateral support and the second lateral support.

151. The towel rack of claim 150, wherein the vent is located in at least one of the laterally extending cross structure, the first lateral support, and the second lateral support and is in fluid communication with the fluid flow path.

152. The towel rack of claim 142, further comprising an aromatherapy cartridge in fluid communication with the fluid flow path so that the air emitted from the vent is mixed with aromatherapy particles from the aromatherapy cartridge.

153. The towel rack of claim 142, wherein the towel rack is configured to kill at least one of a pathogen, germ, bacterium, a virus, or combinations thereof.

154. The towel rack of claim 142, further comprising a horizontally moveable slat that slides along the laterally extending cross structure to facilitate increasing heat capture.

155. The towel rack of claim 142, wherein the towel rack is configured to heat an article, garment, or towel to a pre-selected temperature in a range of 135° F.-220° F. and maintain that pre-selected temperature for a pre-selected period of time in a range of 10 sec.-120 min.

156. The towel rack of claim 155, wherein the towel rack is further configured to cool the article, garment, or towel to a temperature which is less than the pre-selected temperature.

157. A method of heating an article, garment, or towel to a pre-selected temperature in a range of 135° F.-220° F. and maintaining that pre-selected temperature for a pre-selected period of time in a range of 10 sec.-120 min.

158. The method of claim 157, further comprising cooling the article, garment, or towel to a temperature which is less than the pre-selected temperature.

159. The method of claim 157, wherein the heating is sufficient to kill a pathogen, germ, bacterium, a virus, or combinations thereof.

160. The method of claim 159, further comprising cooling the article, garment, or towel to a temperature which is less than the pre-selected temperature.

161. A towel rack comprising:
a base;
a first lateral sidewall extending from the base;
a second lateral sidewall extending from the base, wherein ends of the first lateral sidewall and ends of the second lateral sidewall are configured to form a space between the first lateral sidewall and the second lateral sidewall, wherein at least one of the first lateral sidewall and the second lateral sidewall are configured to provide a fluid flow path which traverses the respective first lateral sidewall and second lateral sidewall;
a forced air unit;
a heating element to heat air which is moved via the forced air unit through the fluid flow path; and
an internal vent located in the at least one of the first lateral sidewall and the second lateral sidewall and in fluid communication with the fluid flow path and configured to emit the air into the space, wherein the first lateral sidewall, the second lateral sidewall, or a combination thereof, is configured to support at least one towel.
